(19) United States
(12) Patent Application Publication
(10) Pub. No.: US 2009/0079264 A1
(43) Pub. Date: Mar. 26, 2009

(54) POWER DEVICE AND STORAGE APPARATUS

(75) Inventor: Akira Minami, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/212,164

(22) Filed: Sep. 17, 2008

(30) Foreign Application Priority Data
Sep. 21, 2007 (JP) 2007-244700

(51) Int. Cl. H02J 1/10

(52) U.S. Cl. 307/44

(57) ABSTRACT

One aspect of the embodiments utilizes a power adapter includes a main USB connector, an assist USB connector, a drive USB connector, and a power supply current combining circuit that combines a current from a power supply terminal of the main USB connector and a current from a power supply terminal of the assist USB connector so as to output a combined current to a power supply terminal of the drive USB connector. The adapter mutually inputs/outputs signals between the signal terminals of the main USB connector and the signal terminals of the drive USB connector.

### CROSS-REFERENCE TO RELATED APPLICATION

This application is based upon and claims the benefit of priority to Japanese Patent Application No. 2007-244700, filed on Sep. 21, 2007, the entire contents of which are incorporated herein by reference.

### BACKGROUND

1. Field of the Invention

The embodiments discussed herein are directed to a power adapter and a storage apparatus used to connect a storage device, such as a hard disk drive, to a personal computer or the like via a USB (Universal Serial Bus) cable.

2. Description of the Related Art

In a conventional portable storage apparatus used in connection with an apparatus such as a personal computer or a server, via a USB cable, it is convenient to use a power supply of 5 volts provided in a USB interface.

The USB interface is provided with a bus power supply with a VBUS line and a ground line in addition to a signal line, which is useful for supplying power to an externally-connected apparatus used in a personal computer or the like. Typical specifications of a bus power supply of a USB are 5 volts/500 milliamperes. However, the amount of current may be less in some personal computers, or a large current load may be imposed at activation in a hard disk drive or the like. Depending on the load condition, operation of an externally-connected apparatus, such as a storage apparatus, may become unstable.

In such a case, the following method has been used. That is, two USB ports are used for parallel wiring with a cable including only a VBUS line and a ground line extending from the second USB port, and the currents are added by performing the common connection.

As a specific configuration, a combining circuit is provided in the middle of a Y-shape-branched special cable so that currents are combined. Alternatively, two USB connectors are provided on the side of a storage apparatus, the USB connectors are connected to a personal computer via two USB cables, and currents are combined in the storage apparatus.

Reference documents are examined Japanese utility model Publication No. 3,109,868, Japanese Laid-open Patent Publication Nos. 2005-346123 and 2005-301390.

### Problem to be Solved by First Technique

However, according to such a conventional method of using a Y-shape-branched special cable to combine currents of bus powers from two USB ports and supply power to a load, it is necessary to prepare a special cable including three USB cables extending from the portion of a current combining circuit placed in the middle of the cable, the ends of the three USB cables being provided with USB connectors. Accordingly, a problem of extra cost arises.

It is an object of the first technique of the present embodiment to provide a power adapter capable of easily supplying a sufficient operating current by combining a plurality of USB bus powers by using commercially-available USB cables even in an apparatus having a single USB port.

### Problem to be Solved by Second Technique

On the other hand, in the case where currents of two USB power supplies are combined in a storage apparatus, connection can be made by using two commercially-available USB cables advantageously. However, the USB standard prohibits a reverse current to a host apparatus, such as a personal computer. If two VBUS lines are simply connected in common in the apparatus, a reverse current occurs when there is a potential difference in bus power supply voltage between ports. In such a case, measures are taken to prevent a reverse current by providing diodes in the middle of the respective two VBUS lines.

However, in the case where diodes are provided to prevent a reverse current that would occur in common connection between two bus power supplies, a forward voltage drop of 0.7 to 1.0 volts occurs in an ordinary rectifying silicon diode, whereas a forward voltage drop of 0.3 to 0.4 volts occurs in a Schottky diode. In such a state, although currents are combined, the drop in voltage causes an unstable operation of an externally-connected apparatus, such as a storage apparatus, depending on a load state.

It is an object of the second technique of the embodiment to provide a storage apparatus that enables a stable operation of a load by minimizing a drop in voltage when two bus power supplies are connected in common to prevent a reverse current.

### SUMMARY

In keeping with one aspect of an embodiment of this technique, a power adapter includes a main USB connector, an assist USB connector, and a drive USB connector. The power adapter includes a power supply current combining circuit that combines a current from a power supply terminal of the main USB connector and a current from a power supply terminal of the assist USB connector so as to output a combined current to a power supply terminal of the drive USB connector. The circuit mutually inputs/outputs signals between the signal terminals of the main USB connector and the signal terminals of the drive USB connector.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed are exemplary and explanatory only and are not restrictive of the embodiment, as claimed.

### BRIEF DESCRIPTION OF THE DRAWINGS

FIG. 1A is a diagram showing an embodiment of a two-input power adapter (front surface) according to a first technique;

FIG. 1B is a diagram showing an embodiment of the two-input power adapter (rear surface) according to the first technique;

FIG. 2 is a circuit diagram showing an embodiment of a power supply current combining circuit included in the power adapter shown in FIGS. 1A and 1B;

FIG. 3 is a diagram showing a conventional connection state between a personal computer and a storage subsystem using a USB cable;

FIG. 4 is a block diagram showing the internal configuration of the storage subsystem shown in FIG. 3;

FIG. 5 is a diagram showing a connection state between the personal computer and the storage subsystem using the power adaptor shown in FIGS. 1A and 1B;

FIG. 6 is a diagram showing a conventional connection state between the personal computer and the storage subsystem using a USB cable and an e-SATA cable;

FIG. 7 is a block diagram showing the internal configuration of the storage subsystem shown in FIG. 6;

FIG. 8 is a diagram showing a conventional connection state between the personal computer and the storage subsystem using an AC adapter and an e-SATA cable;

FIG. 9 is a diagram showing another connection state between the personal computer and the storage subsystem using the power adapter shown in FIGS. 1A and 1B;

FIG. 10A is a diagram showing another embodiment of the two-input power adapter according to the first technique;

FIG. 10B is a diagram showing another embodiment of the two-input power adapter according to the first technique;

FIG. 11 is a circuit diagram showing another embodiment of the power supply current combining circuit included in the power adapter shown in FIGS. 1A and 1B or FIGS. 10A and 10B;

FIG. 12 is a circuit diagram showing another embodiment of the power supply current combining circuit included in the power adapter shown in FIGS. 1A and 1B or FIGS. 10A and 10B;

FIG. 13 is a circuit block diagram showing an embodiment of a voltage doubler circuit shown in FIG. 12;

FIG. 14 is a circuit diagram showing another embodiment of the power supply current combining circuit included in the power adapter shown in FIGS. 1A and 1B or FIGS. 10A and 10B;

FIG. 15 is a characteristic graph showing the relationship between voltage and current of assist USB power supply according to the embodiment shown in FIG. 12;

FIG. 16A is a diagram showing an embodiment of a three-input power adapter (front surface) according to a second technique;

FIG. 16B is a diagram showing an embodiment of the three-input power adapter (rear surface) according to the second technique;

FIG. 17 is a circuit diagram showing an embodiment of a power supply current combining circuit included in the power adapter shown in FIGS. 16A and 16B;

FIG. 18 is a diagram showing a connection state between the personal computer and the storage subsystem using the power adapter shown in FIGS. 16A and 16B;

FIG. 19 is a diagram showing another connection state between the personal computer and the storage subsystem using the power adapter shown in FIGS. 16A and 16B;

FIG. 20 is a diagram showing another connection state between the personal computer and the storage subsystem using the power adapter shown in FIGS. 16A and 16B;

FIG. 21 is a diagram showing another connection state between the personal computer and the storage subsystem using the power adapter shown in FIGS. 16A and 16B;

FIG. 22 is a diagram showing another connection state between the personal computer and the storage subsystem using the power adapter shown in FIGS. 16A and 16B;

FIG. 23A is a diagram showing another embodiment of the three-input power adapter (front surface) according to the second technique;

FIG. 23B is a diagram showing another embodiment of the three-input power adapter (rear surface) according to the second technique;

FIG. 24 is a circuit diagram showing another embodiment of the power supply current combining circuit included in the power adapter shown in FIGS. 16A and 16B or FIGS. 23A and 23B;

FIG. 25 is a circuit diagram showing another embodiment of the power supply current combining circuit included in the power adapter shown in FIGS. 16A and 16B or FIGS. 23A and 23B;

FIG. 26 is a circuit diagram showing another embodiment of the power supply current combining circuit included in the power adapter shown in FIGS. 16A and 16B or FIGS. 23A and 23B;

FIG. 27 is a diagram showing a hard disk subsystem as an embodiment of a storage apparatus according to a third technique of the embodiment;

FIG. 28 is a block diagram showing the internal configuration of the hard disk subsystem according to an embodiment of the third technique;

FIG. 29 is a block diagram showing the circuit function of the hard disk subsystem according to an embodiment of the third technique;

FIG. 30 is a circuit diagram showing an embodiment of a power supply circuit shown in FIG. 29; and

FIG. 31 is a circuit diagram showing another embodiment of the power supply circuit shown in FIG. 29.

### DESCRIPTION OF THE PREFERRED EMBODIMENTS

### Embodiment of First Technique

### Two-Input Combining Power Adapter

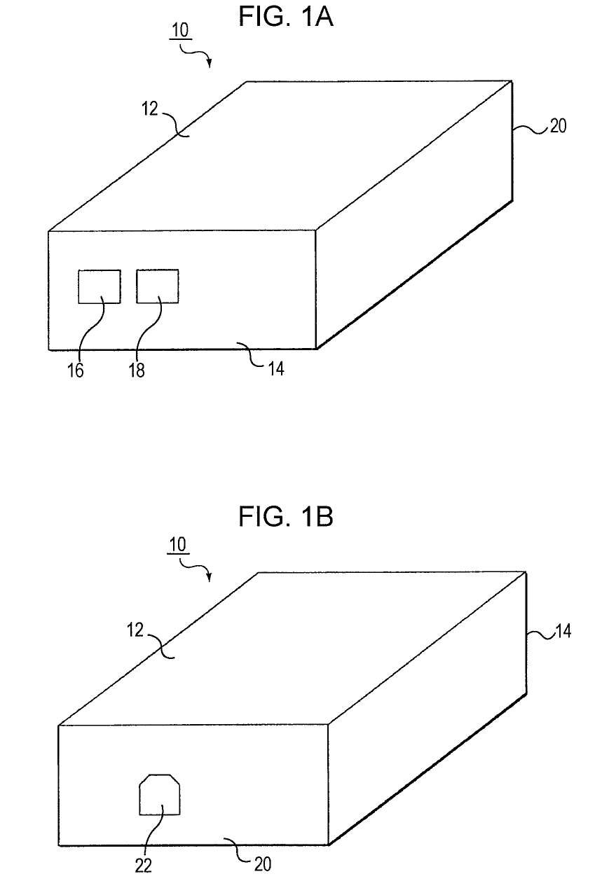

FIGS. 1A and 1B are diagrams showing an embodiment of a two-input power adapter according to the first technique of the embodiment.

FIG. 1A is a diagram of a power adapter 10 of this embodiment viewed from the side of a front surface 14. A main USB connector 16 and an assist USB connector 18 are provided on the front surface 14 of a box-shaped main body 12. Connectors of USB cables from USB ports of a host apparatus, such as a personal computer or a server, are connected to the main USB connector 16 and the assist USB connector 18.

Here, a B-type or mini-B-type USB female connector is used as the main USB connector 16. Also, a B-type or mini-B-type USB female connector is used as the assist USB connector 18.

FIG. 1B is a diagram of the power adapter 10 viewed from the side of a rear surface 20. A drive USB connector 22 as an outputting connector is provided on the rear surface 20 of the power adapter 10. Specifically, an A-type USB female connector is used as the drive USB connector 22. A connector of a USB cable from a storage subsystem on the load side is connected to the drive USB connector 22.

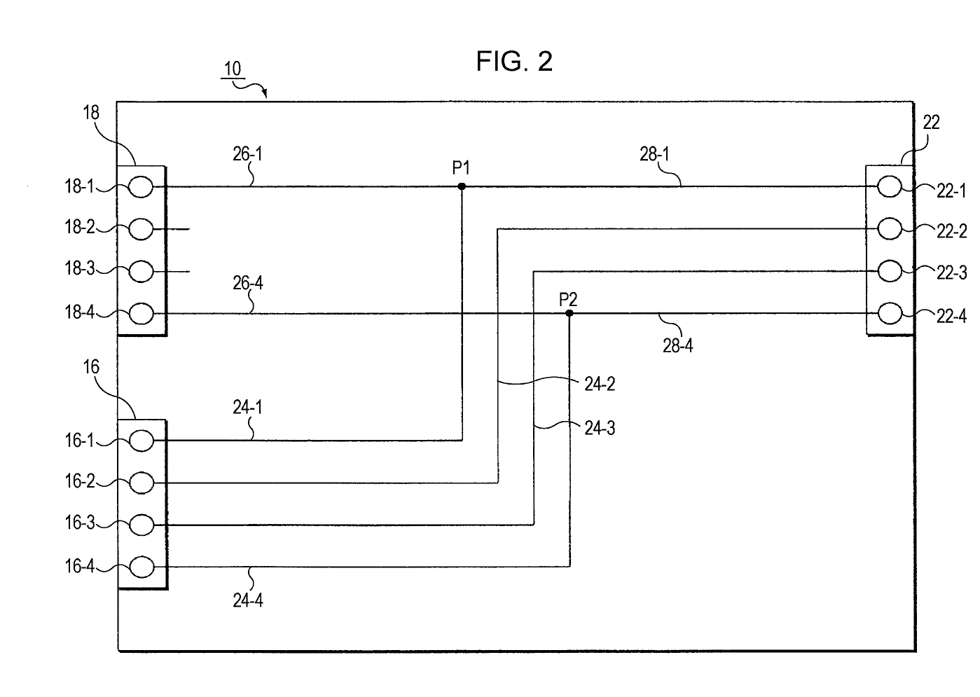

FIG. 2 is a circuit diagram showing an embodiment of a power supply current combining circuit included in the power adapter 10 shown in FIGS. 1A and 1B. Referring to FIG. 2, the main USB connector 16 and the assist USB connector 18 are provided on the input side of the power adapter 10, and the drive USB connector 22 is provided on the output side thereof.

The main USB connector 16 includes four connector pins 16-1, 16-2, 16-3, and 16-4. The connector pin 16-1 is a pin known as a Vbus pin and is supplied with DC power at 5 volts from a USB port. The connector pins 16-2 and 16-3 are signal pins known as a D− pin and a D+ pin. The connector pin 16-4 is a ground pin known as a GND.

Such a configuration of the four connector pins is the same in the assist USB connector 18. That is, connector pins 18-1 to 18-4 are a Vbus pin, a D− pin, a D+ pin, and a GND pin, respectively. Likewise, four connector pins 22-1 to 22-4 of the drive USB connector 22 on the output side are a Vbus pin, a D− pin, a D+ pin, and a GND pin, respectively.

A main USB power supply line 24-1 extends from the connector pin 16-1 of the main USB connector 16, and a USB ground line 24-4 extends from the connector pin 16-4. Furthermore, USB signal lines 24-2 and 24-3 extend from the connector pins 16-2 and 16-3 of the main USB connector 16 and connect to the connector pins 22-2 and 22-3 of the drive USB connector 22 on the output side.

An assist USB power supply line 26-1 extends from the connector pin 18-1 of the assist USB connector 18 and connects to the main USB power supply line 24-1 extending from the main USB connector 16 at a point P1, which connects to the connector pin 22-1 of the drive USB connector 22 through a common USB power supply line 28-1.

Also, a USB ground line 26-4 extends from the connector pin 18-4 of the assist USB connector 18 and connects to the USB ground line 24-4 extending from the connector pin 16-4 of the main USB connector 16 at a point P2, which connects to the connector pin 22-4 of the drive USB connector 22 through a common USB ground line 28-4.

On the other hand, no signal line extends from the connector pins 18-2 and 18-3 for signals of the assist USB connector 18. With this configuration, the assist USB connector 18 serves as a connector that is used only for supplying power from a USB port.

The power supply current combining circuit included in the power adapter 10 shown in FIG. 2 is capable of combining currents flowing from the main USB connector 16 through the main USB power supply line 24-1 and the ground line 24-4 with currents flowing from the assist USB connector 18 through the assist USB power supply line 26-1 and the USB ground line 26-4 at the points P1 and P2, outputting the combined currents to the connector pins 22-1 and 22-4 of the drive USB connector 22 through the USB power supply line 28-1 and the USB ground line 28-4 on the common side, and supplying the combined currents from the two USB ports to the load side connected to the drive USB connector 22, for example, to the storage subsystem.

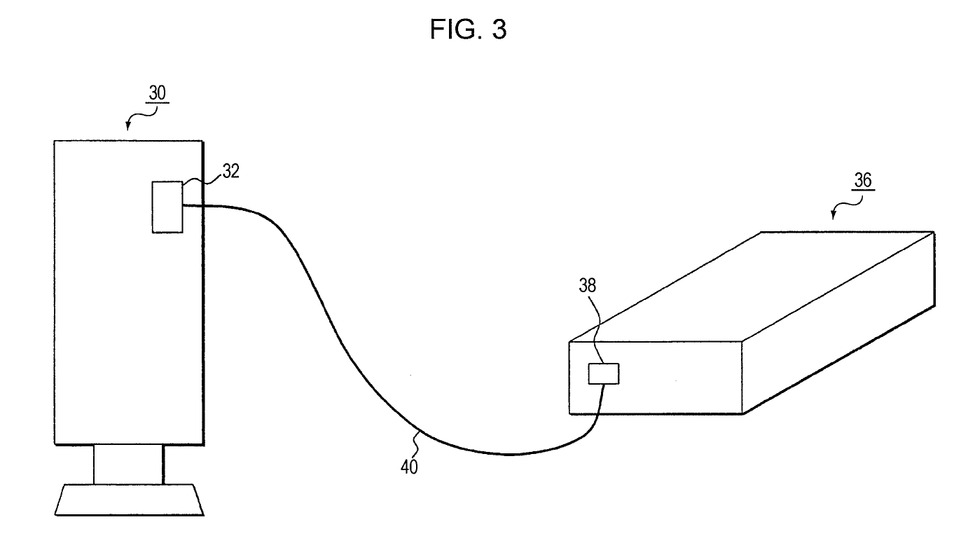

FIG. 3 is a diagram showing a conventional connection state between a personal computer 30 and a storage subsystem 36 using a USB cable. Referring to FIG. 3, a USB connector 32 of a USB cable 40 is connected to a USB port of the personal computer 30, and a USB connector 38 of the USB cable 40 is connected to a USB port of the storage subsystem 36.

In this state where the storage subsystem 36 is connected to the personal computer 30 through the USB cable 40 via the connectors, power is supplied from the personal computer 30 to the storage subsystem 36 with typical specifications of a USB bus power supply, that is, DC 5 volts/500 milliamperes. Accordingly, the storage subsystem 36 is activated and can store or reproduce data in response to an input/output request from the personal computer 30.

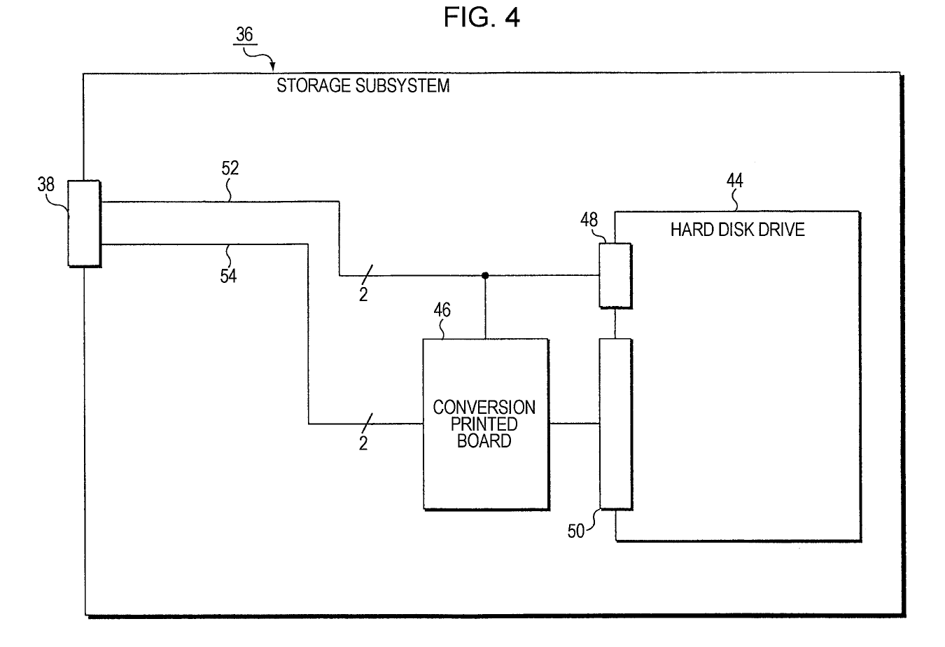

FIG. 4 is a block diagram showing the internal configuration of the storage subsystem 36 shown in FIG. 3. Referring to FIG. 4, a hard disk drive 44 and a conversion printed board 46 are incorporated into the storage subsystem 36. A USB power supply cable 52 extends from the USB connector 38 and connects to a power supply connector 48 of the hard disk drive 44. Also, a USB signal cable 54 extends from the USB connector 38 and connects to the conversion printed board 46.

An interface of the hard disk drive 44 is an ATA interface, for example, and connects to the conversion printed board 46 via an ATA connector 50. The conversion printed board 46 is provided with a USB/ATA conversion LSI, which performs mutual conversion of a USB interface signal and an ATA interface signal between the USB connector 38 and the ATA connector 50.

As the USB/ATA conversion LSI provided on the conversion printed board 46, USB 2.0-ATA Bridge INIC-1510 made by Initio Corporation is used, for example.

However, in the conventional connection made with only one USB cable 40 as shown in FIG. 3, since the power supply from the USB port of the personal computer 30 is based on the typical specifications of 5 volts/500 milliamperes, a large load current flows in the hard disk drive 44 shown in FIG. 4 included in the storage subsystem 36 at activation, and thus an activating current that exceeds a maximum current of 500 milliamperes supplied from the USB bus power supply is necessary. For this reason, the operation of the externally-connected storage subsystem 36 becomes unstable depending on a status of the hard disk drive 44.

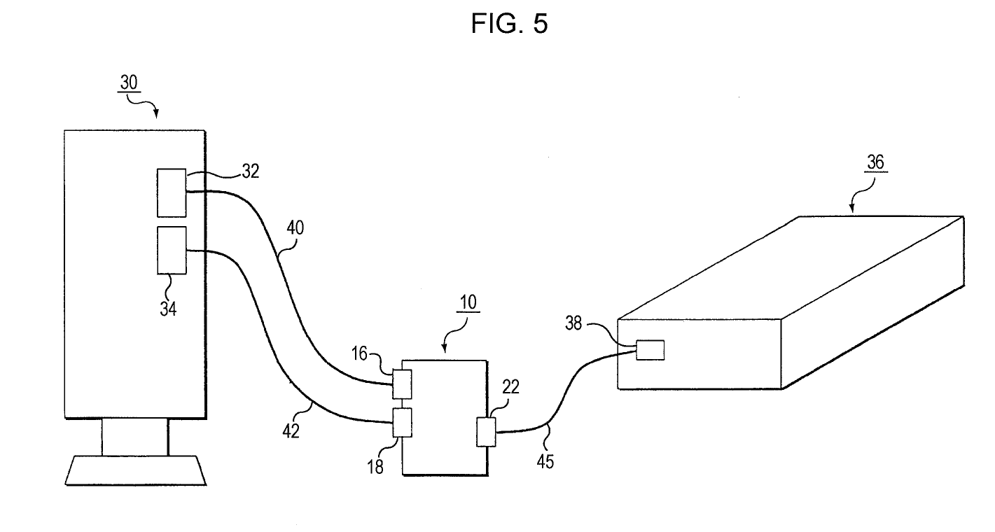

Accordingly, in this embodiment, connection between the personal computer 30 and the storage subsystem 36 is performed by using the power adapter 10 according to the embodiment shown in FIGS. 1A and 1B, as shown in FIG. 5.

Referring to FIG. 5, the personal computer 30 is connected to the storage subsystem 36 by using the power adapter 10 according to the embodiment shown in FIGS. 1A and 1B. The personal computer 30 is provided with at least two USB connectors 32 and 34. Thus, the USB connector 32 of the personal computer 30 is connected to the main USB connector 16 of the power adapter 10 by using the USB cable 40. Also, the USB connector 34 of the personal computer 30 is connected to the assist USB connector 18 of the power adapter 10 by using a USB cable 42.

Then, the drive USB connector 22 of the power adapter 10 is connected to the USB connector 38 of the storage subsystem 36 by using a USB cable 45. Accordingly, the power adapter 10 can supply a combined current of bus powers from the two USB connectors 32 and 34 of the personal computer 30 to the storage subsystem 36.

For example, assume that the specifications of each of the two USB connectors 32 and 34 are 5 volts/500 milliamperes. In that case, the power adapter 10 can supply power of 5 volts/1000 milliamperes to the storage subsystem 36 by combining currents from the two USB bus power supplies. Accordingly, even if the storage subsystem 36 is in an operation state where a current supply of 5 volts/500 milliamperes from one USB port is insufficient, a stable operation can be ensured by enabling substantially double current supply.

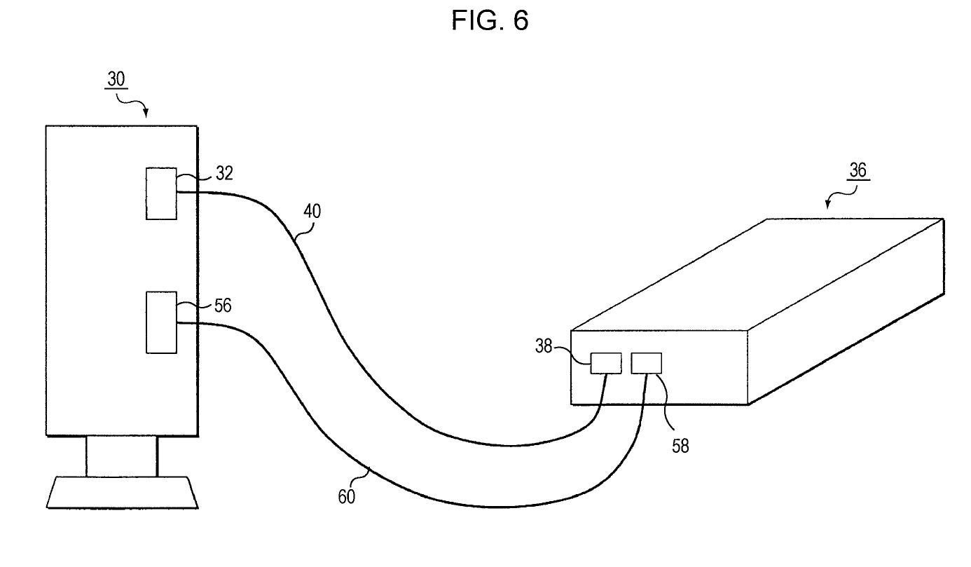

FIG. 6 is a diagram showing a conventional connection state between the personal computer 30 and the storage subsystem 36 using the USB cable 40 and an e-SATA cable 60. Referring to FIG. 6, the personal computer 30 is provided with an e-SATA (external-SATA) connector 56 in addition to the USB connector 32. In correspondence with these connectors, the storage subsystem 36 is provided with the SUB connector 38 and an e-SATA connector 58.

In such a case, an e-SATA interface of the personal computer 30 does not have a function to supply power, and thus bus power is supplied to the storage subsystem 36 by using an USB interface so that the storage subsystem 36 is operated.

That is, the USB connector 32 of the personal computer 30 is connected to the USB connector 38 of the storage subsystem 36 by using the USB cable 40 so as to supply power of 5 volts/500 milliamperes. On the other hand, for the e-SATA interface, the e-SATA connector 56 of the personal computer 30 is connected to the e-SATA connector 58 of the storage subsystem 36 by using the e-SATA cable 60.

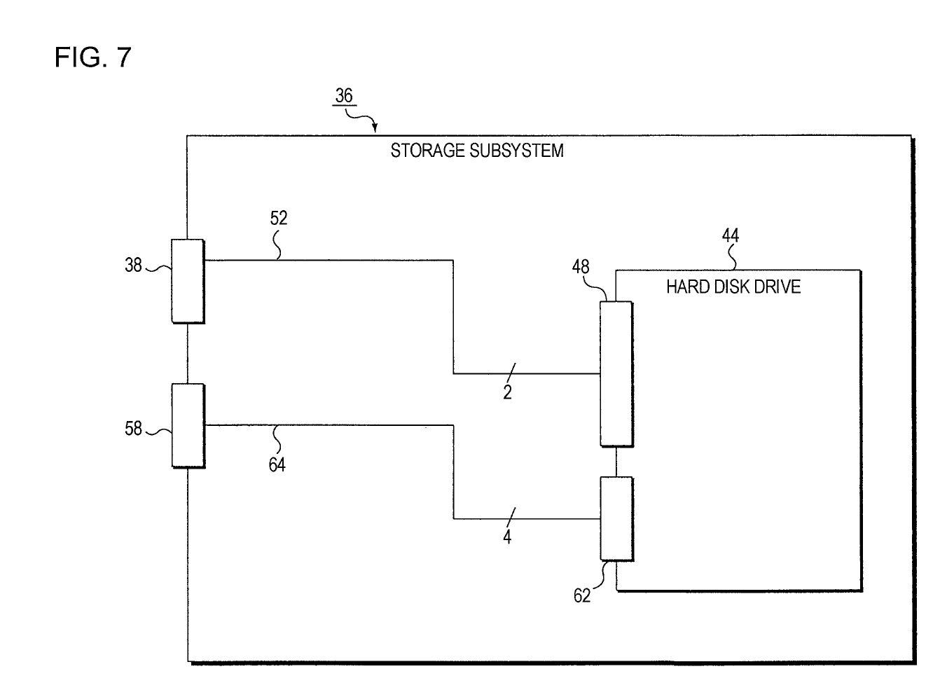

FIG. 7 is a diagram showing the internal configuration of the storage subsystem 36 shown in FIG. 6. Referring to FIG. 7, the storage subsystem 36 includes the hard disk drive 44 which is provided with a SATA interface as an external interface.

The USB connector 38 connects to the power supply connector 48 of the hard disk drive 44 through the USB power supply cable 52. The USB power supply cable 52 includes only two signal lines: a power supply line and a ground line, not including a USB signal line. An operation is performed by supplying bus power of 5 volts/500 milliamperes to the USB connector 38 from the personal computer 30.

The e-SATA connector 58 connects to a SATA signal connector 62 of the hard disk drive 44 through a SATA signal cable 64. Typically, the SATA signal cable 64 includes four signal lines: a pair of uplink lines and a pair of downlink lines.

However, in the case where the storage subsystem 36 is connected to the personal computer 30 by using one USB cable 40 as shown in FIG. 6, a sufficient load current at activation of the hard disk drive 44 provided in the storage subsystem 36 may not be supplied as in the conventional example shown in FIG. 3 if a typical USB interface having specifications of 5 volts/500 milliamperes is used, which causes a problem of an unstable operation.

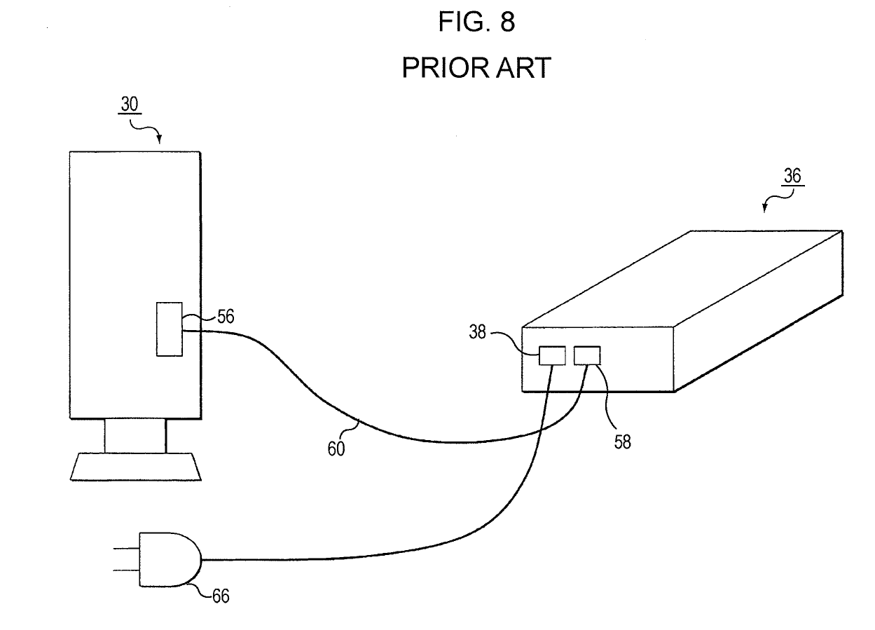

As measures against such an insufficient load current to the storage subsystem, a conventional method of using an AC adapter 66 may be used as shown in FIG. 8, for example. Referring to FIG. 8, the e-SATA connector 56 of the personal computer 30 is connected to the e-SATA connector 58 of the storage subsystem 36 by using the e-SATA cable 60. Also, the AC adapter 66 is connected to the USB connector 38 of the storage subsystem 36, and the AC adapter 66 converts commercial AC power to specific DC power, which is supplied.

As the AC adapter 66, an adapter having a high current-supplying ability is used so that a sufficient load current at activation of the hard disk drive 44 provided in the storage subsystem 36 can be supplied. Accordingly, a large and expensive adapter is necessary as the AC adapter 66.

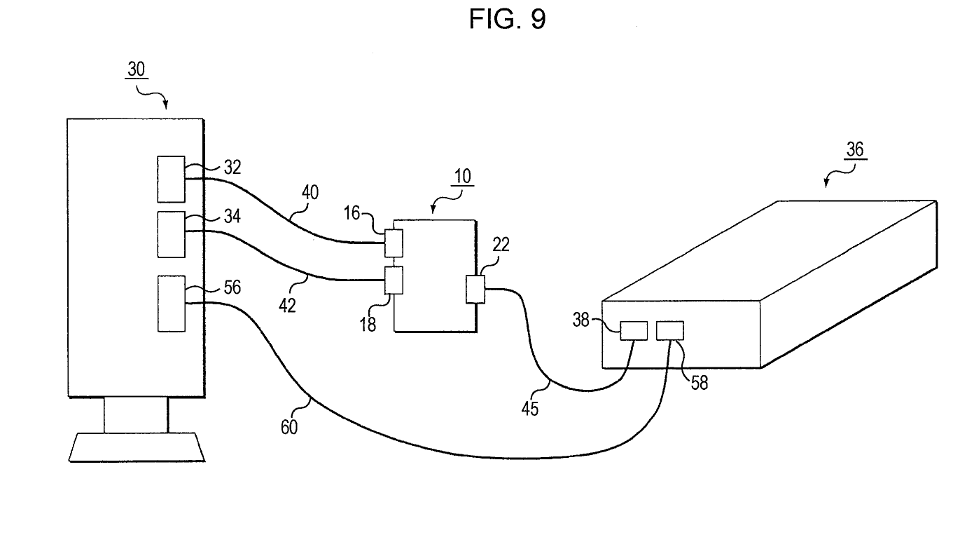

FIG. 9 is a diagram showing a connection state between the personal computer 30 and the storage subsystem 36 using the e-SATA cable 60 and the power adapter 10 shown in FIGS. 1A and 1B. With this connection, current supply from the USB bus power supply is sufficiently ensured and a stable operation is realized.

Referring to FIG. 9, the storage subsystem 36 is connected to the personal computer 30 by using the power adapter 10 according to this embodiment. That is, the USB connector 32 of the personal computer 30 is connected to the main USB connector 16 of the power adapter 10 by using the USB cable 40, and the drive USB connector 22 of the power adapter 10 is connected to the USB connector 38 of the storage subsystem 36 by using the USB cable 45. Furthermore, as in the conventional manner, the e-SATA connector 56 of the personal computer 30 is connected to the e-SATA connector 58 of the storage subsystem 36 by using the e-SATA cable 60.

In such a case where the storage subsystem 36 is connected to the personal computer 30 by using the e-SATA cable 60, currents of bus powers from the two USB connectors 32 and 34 of the personal computer 30 are combined by using the power adapter 10 according to this embodiment. When each USB port has specifications of 5 volts/500 milliamperes, for example, combining of currents by the power adapter 10 enables bus power of 5 volts/1000 milliamperes to be supplied to the storage subsystem 36, so that a sufficient load current at activation of the hard disk drive can be supplied and a stable operation can be ensured.

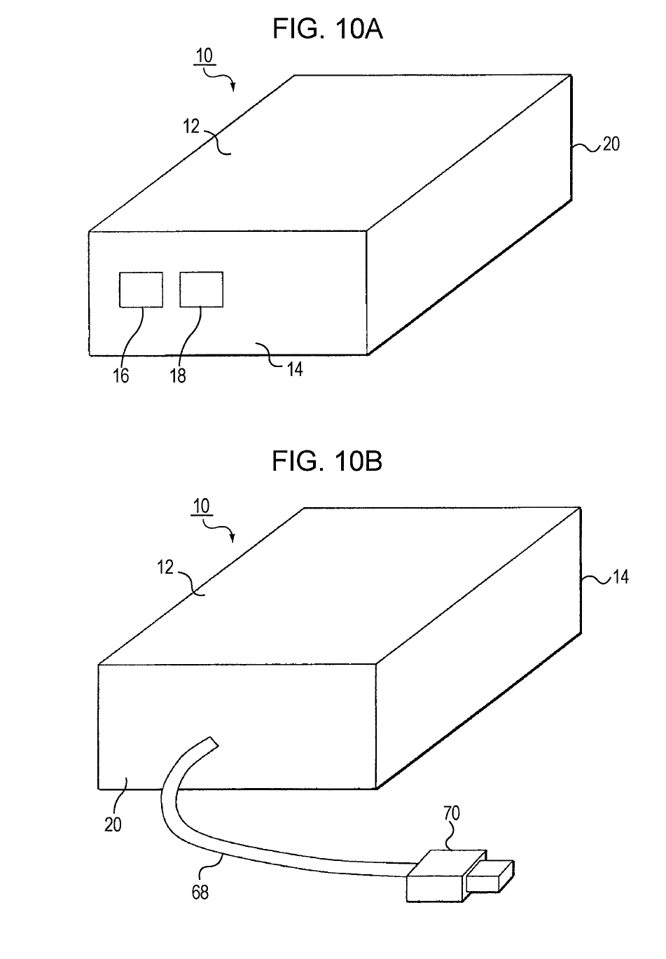

FIGS. 10A and 10B are diagrams showing another embodiment of the two-input power adapter according to the first technique of the embodiment. FIG. 10A is a diagram showing the power adapter 10 viewed from the side of the front surface 14. As in the embodiment shown in FIG. 1A, the main USB connector 16 which is a B-type or mini-B-type female connector and the assist USB connector 18 which is a B-type or mini-B-type female connector are provided on the front surface 14.

On the side of the rear surface 20 shown in FIG. 10B, a USB cable 68 extends directly from the inside of the main body 12, and a drive USB connector 70 which is a B-type USB male connector connects to the end of the USB cable 68.

In this way, by providing the USB cable 68 provided with the drive USB connector 70 such that it extends directly from the rear surface 20, the USB cable 45 on the side of the storage subsystem 36 is unnecessary when the personal computer 30 is connected to the storage subsystem 36 as shown in FIG. 5 or 9. Accordingly, the power adapter 10 can be easily handled.

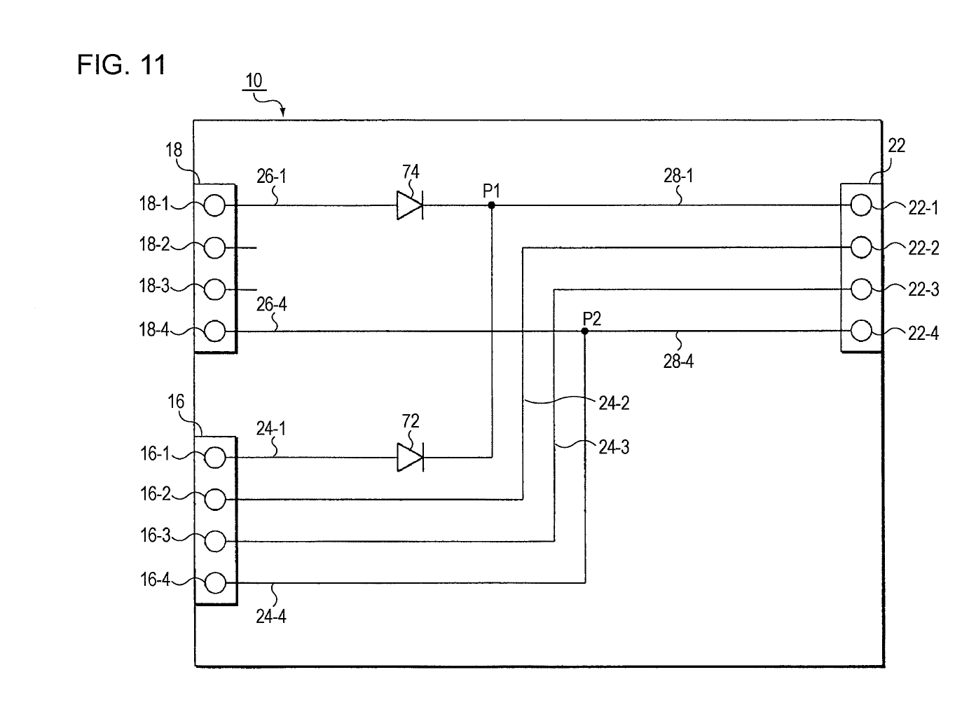

FIG. 11 is a circuit diagram showing another embodiment of the power supply current combining circuit included in the power adapter 10 shown in FIGS. 1A and 1B or FIGS. 10A and 10B. Referring to FIG. 11, the connection configuration of the connector pins 22-1 to 22-4 of the drive USB connector 22 on the output side with respect to the four connector pins 16-1 to 16-4 of the main USB connector 16 and the two connector pins 18-1 and 18-4 of the assist USB connector 18 on the input side of the power adapter 10 is the same as that in the embodiment shown in FIG. 2. Additionally, in the embodiment shown in FIG. 11, a reverse current preventing diode 72 is provided in the middle of the USB power supply line 24-1 extending from the main USB connector 16, and a reverse current preventing diode 74 is provided in the middle of the assist USB power supply line 26-1 extending from the assist USB connector 18. The cathode sides of the diodes 72 and 74 are connected in common at the point P1, which connects to the connector pin 22-1 of the drive USB connector 22 through the USB power supply line 28-1 on the common side.

As described above, the reverse current preventing diodes 72 and 74 are provided in the middle of the USB power supply lines 24-1 and 26-1 extending from the main USB connector 16 and the assist USB connector 18, respectively. With this configuration, when the power adapter 10 is connected to the two USB connectors 32 and 34 of the personal computer 30 by using the USB cables 40 and 42, as shown in FIG. 5 or 9, problems due to a reverse current from a higher-voltage USB connector to a lower-voltage USB connector, which occurs due to a drop in power supply voltage of any one of the USB connectors, can be prevented.

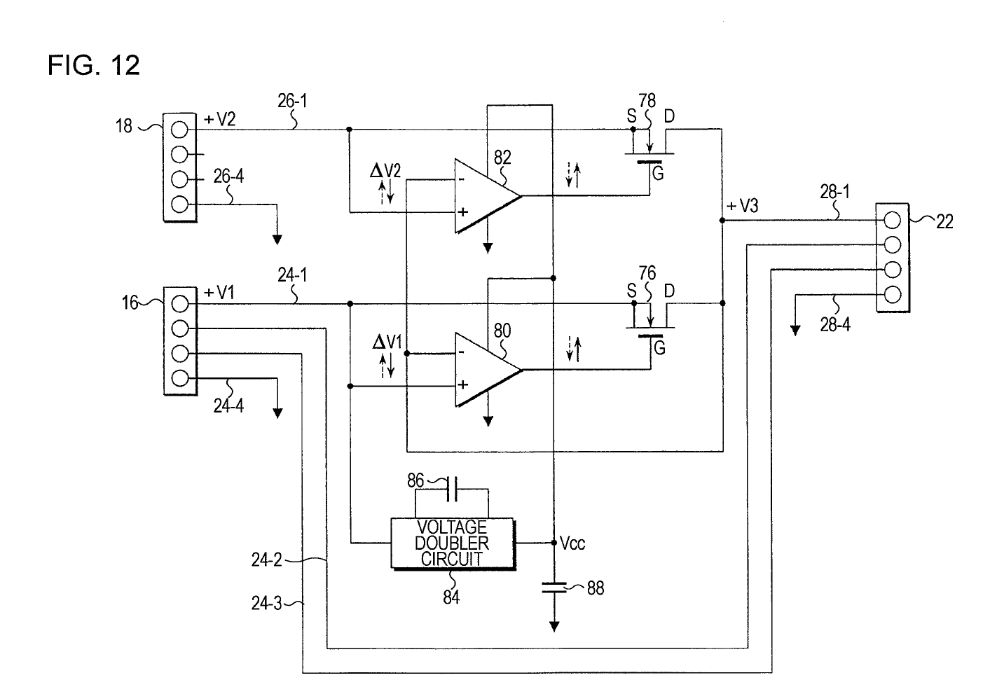

FIG. 12 is a circuit diagram showing another embodiment of the power supply current combining circuit included in the two-input combining power adapter 10 according to the first technique of the embodiment. This circuit enables a stable operation of a load by minimizing a drop in voltage when two bus power supplies are connected in common to prevent a reverse current.

Referring to FIG. 12, an N-channel MOS-FET 76 is provided in the middle of the main USB power supply line 24-1 extending from the main USB connector 16 in this embodiment. On the other hand, an N-channel MOS-FET 78 is provided in the middle of the assist USB power supply line 26-1 extending from the assist USB connector 18.

The N-channel MOS-FETs 76 and 78 have sources S connected to a power supply input side and drains D connected to a power supply output side. The drain D sides are connected in common to the USB power supply line 28-1 which connects to the drive USB connector 22.

On/off of the N-channel MOS-FETs 76 and 78 is controlled by operational amplifiers 80 and 82, respectively. The source S sides of the N-channel MOS-FETs 76 and 78 connect to noninverting input terminals (+) on the input sides of the operational amplifiers 80 and 82. Also, the drain D sides of the N-channel MOS-FETs 76 and 78 connect to inverting input terminals (−) on the input sides of the operational amplifiers 80 and 82. The output sides of the operational amplifiers 80 and 82 connect to gates G of the N-channel MOS-FETs 76 and 78.

Furthermore, a voltage doubler circuit 84 is provided to generate operating power of the operational amplifiers 80 and 82. The voltage doubler circuit 84 boosts a power supply voltage +V1 of 5 volts input through the main USB power supply line 24-1 to almost double (10 volts) in this embodiment by a switched capacitor operation using externally-connected capacitors 86 and 88, and supplies the boosted voltage as a power supply voltage Vcc to the operational amplifiers 80 and 82.

The N-channel MOS-FETs 76 and 78 provided in the main USB power supply line 24-1 and the assist USB power supply line 26-1 are brought into conduction in an on-state when a gate-source voltage Vgs is biased in the positive direction and are controlled to be turned off when the gate-source voltage Vgs is biased in the negative direction.

Here, assume that an input voltage of the main USB power supply line 24-1 is +V1, that an input voltage of the assist USB power supply line 26-1 is +V2, and that an output voltage of the USB power supply line 28-1 to the load is +V3. In this case, the operational amplifiers 80 and 82 perform on-control or off-control of the N-channel MOS-FETs 76 and 78 in the following manner.

Now, assuming that the power supply voltage V1 of the main USB power supply line 24-1 is higher than the power supply voltage V3 on the load side, a voltage ΔV1=V1−V3 is input to the input side of the operational amplifier 80 with the polarity indicated by a solid-line arrow.

Accordingly, the output of the operational amplifier 80 is inversion of the input, that is, a voltage having a positive-side potential indicated by a solid-line arrow. Thus, the N-channel MOS-FET 76 is controlled to be turned on, and the on-resistance thereof is very low, e.g., about 0.01Ω. At this time, a forward voltage drop is very small of 5 millivolts if a current supplied to the load is 500 milliamperes, and thus the power supply voltage V3 to the load can be maintained at a sufficient level.

When the N-channel MOS-FET 76 is controlled to be turned on and inner resistance decreases in accordance with an increase to the positive side in the output of the operational amplifier 80, a differential voltage ΔV1 applied to the input is feedback-controlled to decrease, and the N-channel MOS-FET 76 is negative-feedback-controlled to an on-state with minimum on-resistance.

On the other hand, when the power supply voltage V1 of the main USB power supply line 24-1 is lower than the power supply voltage V3 on the output side, the differential voltage ΔV1 applied to the operational amplifier 80 is an input voltage in the positive direction indicated by a broken-line arrow. Thus, the output of the operational amplifier 80 decreases in the negative direction indicated by a broken-line arrow and controls the N-channel MOS-FET 76 to turn it off while causing inner resistance to be a high (H) impedance, whereby a reverse direction characteristic of an ideal diode is realized.

Therefore, even if the power supply voltage V3 on the output side is higher than the power supply voltage V1 on the input side, a reverse current from the output side to the input side can be prevented by controlling the N-channel MOS-FET 76 to turn it off.

The above-described control of the N-channel MOS-FET 76 by the operational amplifier 80 can be applied to the control of the N-channel MOS-FET 78 provided in the assist USB power supply line 26-1 by the operational amplifier 82.

Now, assuming that the power supply voltage V2 of the assist USB power supply line 26-1 is higher than the power supply voltage V3 on the load side, a voltage ΔV2=V2−V3 is input to the input side of the operational amplifier 82 with the polarity indicated by a solid-line arrow.

Thus, the output of the operational amplifier 82 is a voltage having a positive-side potential indicated by a solid-line arrow, so that the N-channel MOS-FET 78 is controlled to be turned on. When the N-channel MOS-FET 78 is controlled to be turned on and inner resistance decreases in accordance with an increase to the positive side in output of the operational amplifier 82, a differential voltage ΔV2 applied to the input is feedback-controlled to decrease, and the N-channel MOS-FET 78 is negative-feedback-controlled to an on-state with minimum on-resistance.

On the other hand, when the power supply voltage V2 of the assist USB power supply line 26-1 is lower than the power supply voltage V3 on the output side, the differential voltage ΔV2 applied to the operational amplifier 82 is an input voltage in the positive direction indicated by a broken-line arrow. Thus, the output of the operational amplifier 82 decreases in the negative direction indicated by a broken-line arrow and controls the N-channel MOS-FET 78 to turn it off while causing inner resistance to be H impedance, whereby a reverse direction characteristic of an ideal diode is realized.

In this case, each of the input voltages V1 and V2 of the operational amplifiers 80 and 82 is 5 volts. Since the operational amplifiers 80 and 82 need to change an output voltage with a threshold of 5 volts, almost double of the threshold 5 volts, that is, 10 volts is necessary as the power supply voltage Vcc, which is generated by the voltage doubler circuit 84.

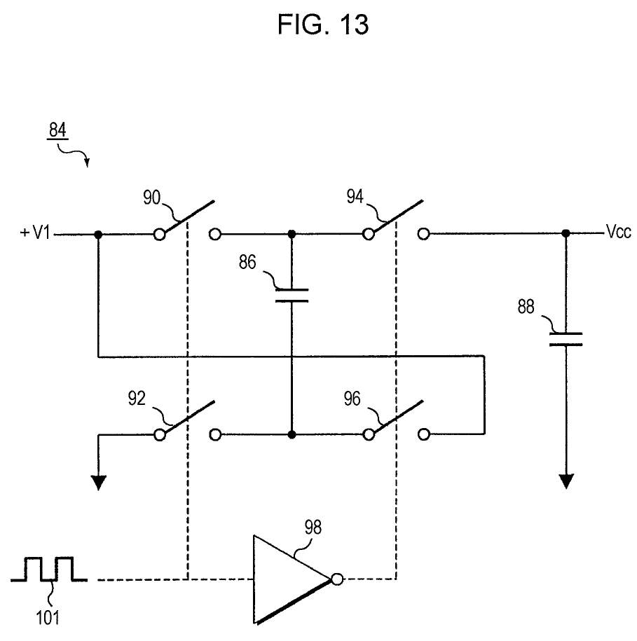

FIG. 13 is a circuit block diagram showing an embodiment of the voltage doubler circuit 84 shown in FIG. 12. Referring to FIG. 13, the voltage doubler circuit 84 includes four switches 90, 92, 94, and 96; an inverter 98 to control on/off of the four switches; and two capacitors 86 and 88 to boost a voltage by a switched capacitor operation.

The signal line of the input voltage V1 connects to the output side via the switches 90 and 94. The power supply line of the input voltage V1 branches before the switch 90 and connects to the ground side via the switches 96 and 92.

The capacitor 86 connects between the switches 90 and 94 and the switches 92 and 96. The capacitor 88 connects to the output side of the switch 94. The switches 90 and 92 are controlled to be turned on/off in synchronization with clock pulses 101 input from a clock generating circuit (not shown). The clock pulses 101 are inverted by the inverter 98, and the switches 94 and 96 are controlled to be turned on/off in synchronization with the inverted clock pulses generated by the inverter 98.

A voltage boosting operation performed by the voltage doubler circuit 84 is as follows. When the switches 90 and 92 are turned on by the clock pulses 101, the switches 94 and 96 are in an off-state due to inverted clock pulses generated by the inverter 98. When the switches 90 and 92 are turned on, a current from the power supply voltage V1 flows to the ground side through the capacitor 86, so that the capacitor 86 is charged to +V1.

Then, the switches 90 and 92 are turned off and the switches 94 and 96 are turned on at the same time. When the switches 94 and 96 are turned on, the power supply voltage +V1 is applied to the negative side of the capacitor 86 via the switch 96, whereby a sum voltage (V1+V1)=2V1 of the voltage +V1 with which the capacitor 86 has been previously charged and the voltage V1 that has been newly added to the negative side is generated. Then, the capacitor 88 is charged with the sum voltage.

Thereafter, alternate on/off of the switches 90 and 92 and the switches 94 and 96 is repeated in synchronization with the clock pulses 101 and the inverted clock pulses generated by the inverter 98. Accordingly, the power supply voltage Vcc=2V1, which is double of the input voltage V2, can be obtained in the capacitor 88 by a so-called switched capacitor operation.

In this embodiment, the voltage doubler circuit 84 is used as a booster circuit to supply a power supply voltage to the operational amplifiers 80 and 82. Alternatively, an ordinary boosting DC-DC converter may be used.

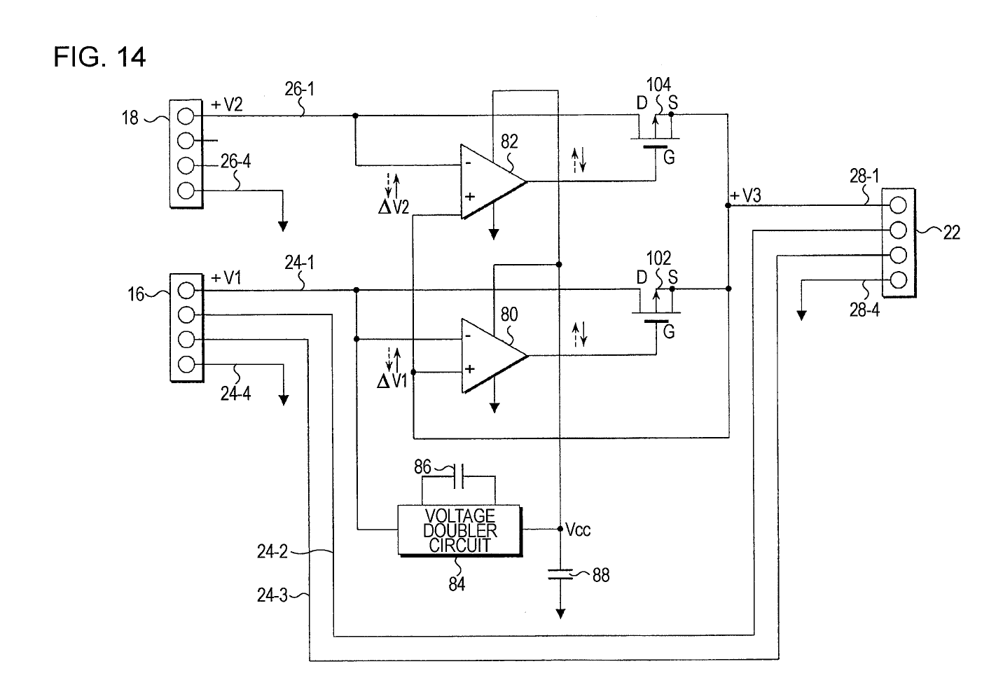

FIG. 14 is a circuit diagram showing another embodiment of the power supply current combining circuit included in the two-input combining power adapter 10 according to the first technique of the embodiment. This embodiment is characterized in that P-channel MOS-FETs are used.

Referring to FIG. 14, P-channel MOS-FETs 102 and 104 are provided in the middle of the main USB power supply line 24-1 extending from the main USB connector 16 and the assist USB power supply line 26-1 extending from the assist USB connector 18, respectively, in this embodiment. That is, drains D of the P-channel MOS-FETs 102 and 104 connect to the power input side, whereas sources S connect in common to the USB power supply line 28-1 on the output side.

On/off of the P-channel MOS-FETs 102 and 104 is controlled by the operational amplifiers 80 and 82. Gate-drain voltages Vgd of the P-channel MOS-FETs 102 and 104 are input to the operational amplifiers 80 and 82. That is, the sources S of the P-channel MOS-FETs 102 and 104 connect to the noninverting input terminals (+) on the input side of the operational amplifiers 80 and 82. Also, the drains D thereof connect to the inverting input terminals (−) on the input side.

The P-channel MOS-FETs 102 and 104 are controlled to be turned on when the gate-drain voltage is biased in the negative direction as indicated by a solid-line arrow and are controlled to be turned off when the gate-drain voltage is biased in the positive direction as indicated by a broken-line arrow.

To the input side of the operational amplifier 80, a differential voltage ΔV1=V1−V3 between the power supply voltage V1 of the main USB power supply line 24-1 and the power supply voltage V3 of the USB power supply line 28-1 on the output side is input. On the other hand, to the operational amplifier 82, a differential voltage ΔV2=V2−V3 between the power supply voltage V2 of the assist USB power supply line 26-1 and the power supply voltage V3 of the USB power supply line 28-1 on the output side is input.

For example, control of the P-channel MOS-FET 102 by the operational amplifier 80 is described. When the power supply voltage V1 of the main USB power supply line 24-1 is higher than the power supply voltage V3 on the output side, the differential voltage ΔV input to the operational amplifier 80 has a polarity indicated by a solid-line arrow. In this case, the output of the operational amplifier 80 is a voltage changing in the negative direction indicated by a solid-line arrow and controls the P-channel MOS-FET 102 to turn it on.

When the P-channel MOS-FET 102 is controlled to be turned on, the on-resistance thereof is about 0.01Ω, for example. Accordingly, a forward voltage drop is only 0.05 millivolts with respect to a typical maximum current of 500 milliamperes of the USB interface.

On the other hand, when the power supply voltage V3 on the output side is higher than the power supply voltage V1 on the input side, the differential voltage ΔV1 input to the operational amplifier 80 has a polarity indicated by a broken-line arrow. In this case, the output of the operational amplifier 80 increases in the positive direction as indicated by a broken-line arrow. Accordingly, the P-channel MOS-FET 102 is controlled to be turned off, a reverse direction characteristic of an ideal diode is realized, and a reverse current from the higher power supply voltage V3 to the lower power supply voltage V1 can be realizably prevented.

The control to turn on/off the P-channel MOS-FET 104 provided in the assist USB power supply line 26-1 by the operational amplifier 82 is the same as in the case of the operational amplifier 80.

The P-channel MOS-FETs 102 and 104 can be controlled to be turned on by changing the output in the negative direction by the operational amplifiers 80 and 82. Thus, when the threshold of the operational amplifiers 80 and 82 is 5 volts corresponding to the input voltages V1 and V2, the output may be biased to 5 volts or lower for on-control.

On the other hand, for off-control, the output of the operational amplifiers 80 and 82 is increased to the positive side from the threshold 5 volts. In the bias to the positive side in this case, the voltage may be increased by about 2 to 3 volts from the threshold 5 volts.

Therefore, in the embodiment shown in FIG. 14, the power supply voltage Vcc supplied from the voltage doubler circuit 84 to the operational amplifiers 80 and 82 may be about 7 to 8 volts. Thus, a smaller and less expensive voltage doubler circuit can be used as the voltage doubler circuit 84 compared to the case in the embodiment shown in FIG. 12, where the power supply voltage Vcc for the operational amplifiers 80 and 82 needs to be 10 volts.

Of course, in the embodiment shown in FIG. 14, too, a boosting DC-DC converter can be used instead of the voltage doubler circuit 84. In that case, a boosted voltage may be 7 to 8 volts. Therefore, a smaller and less expensive DC-DC converter can be advantageously used compared to the embodiment shown in FIG. 9, where the boosted voltage is 10 volts.

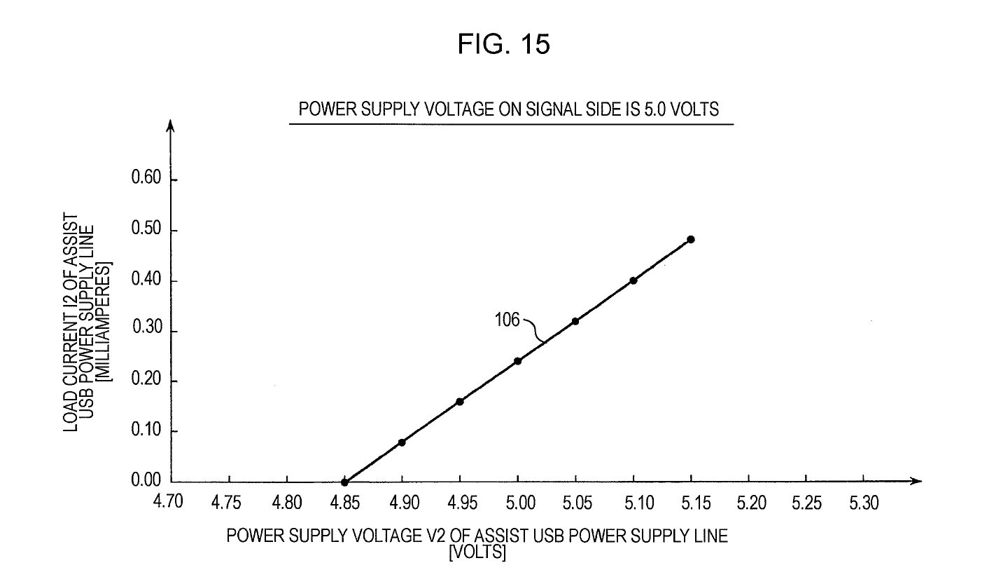

FIG. 15 is a characteristic graph showing a result obtained from measurement of a load current flowing in the assist USB power supply line 26-1, in accordance with changes in power supply voltage V2 of the assist USB power supply line 26-1 in a state where the power supply voltage V1 of the main USB power supply line 24-1 is fixed to 5.0 volts and the output current with respect to the load is fixed to 500 milliamperes, in the embodiment using the N-channel MOS-FETs 76 and 78 shown in FIG. 12.

Referring to FIG. 15, when the assist USB power supply voltage V2 is gradually increased, the assist USB current I2 starts to flow when the voltage V2 reaches 4.85 volts. Thereafter, the assist USB current I2 linearly increases in accordance with the increase of the power supply voltage V2 as indicated by a characteristic 106. When the voltage V2 is 5.15 volts, almost the maximum current 500 milliamperes are shared on the assist side.

Compared to the above-described assist USB current I2, a current I1 calculated by subtracting the assist USB current I2 from 500 milliamperes, that is, I1=500 (milliamperes)−I2, flows on the signal side.

As is clear from the characteristic graph shown in FIG. 15, even if there is a difference between the power supply voltages V1 and V2 of the two USB connectors, the currents from the two connectors according to respective voltages can be added and supplied to the load without causing a reverse current. Also, a forward voltage drop of the MOS-FETs provided for preventing a reverse current is very small. Thus, even in the case where currents are supplied from the two USB connectors and are added, a drop in power supply voltage to be supplied to the load side is very small. Also, even if fluctuation occurs on the side of the hard disk drive as a load, a stable operation of the load can be ensured by supplying a stable power supply voltage and load current.

### Embodiment of Second Technique

### Three-Input Combining Power Adapter

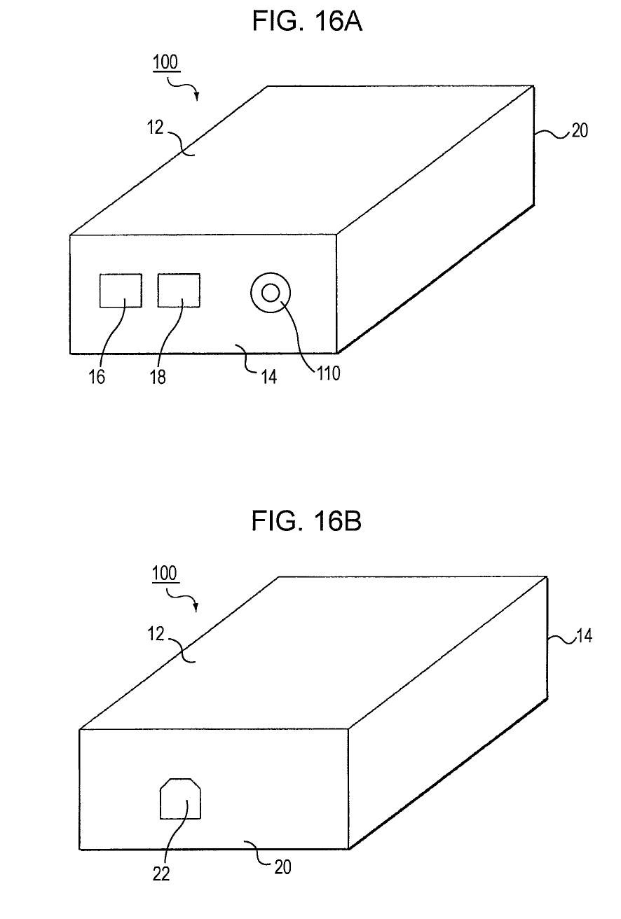

FIGS. 16A and 16B are diagrams showing an embodiment of a three-input power adapter according to the second technique of the embodiment. FIG. 16A shows a three-input power adapter 100 viewed from the side of a front surface 14. A main USB connector 16 and an assist USB connector 18 are provided on the front surface 14 of the main body 12. This point is the same as that in the embodiment shown in FIG. 1A. However, in this embodiment, a DC jack 110 is further provided.

With this configuration, in the power adapter 100, two USB cables from a personal computer can be connected to the main USB connector 16 and the assist USB connector 18. In addition, by connecting an AC adapter to the DC jack 110, currents from three power supply inputs at the maximum can be combined and output.

FIG. 16B shows the power adapter 100 viewed from the side of a rear surface 20. A drive USB connector 22 is provided on the rear surface 20. A storage subsystem is connected to the drive USB connector 22 via a USB cable and receives supply of power and signals.

The main USB connector 16 and the assist USB connector 18 shown in FIG. 16A are B-type or mini-B-type USB female connectors. On the other hand, an A-type USB female connector is used as the drive USB connector 22 shown in FIG. 16B.

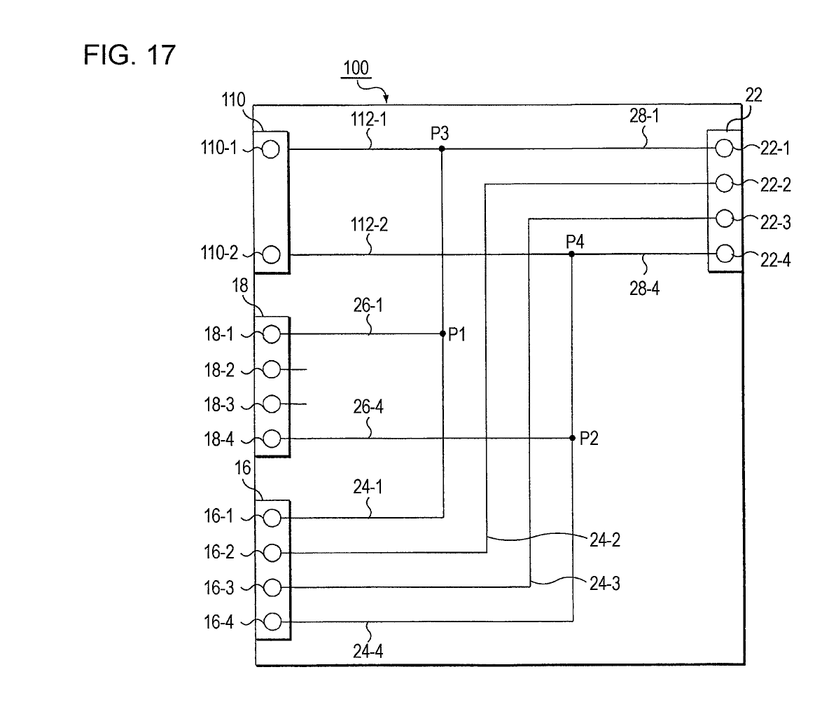

FIG. 17 is a diagram showing an embodiment of a power supply current combining circuit included in the power adapter 100 shown in FIGS. 16A and 16B. Referring to FIG. 17, the main USB connector 16, the assist USB connector 18, and the DC jack 110 are provided on the input side of the power adapter 100.

The main USB connector 16 and the assist USB connector 18 include four connector pins 16-1 to 16-4 and 18-1 to 18-4, respectively, and the DC jack 110 includes connector pins 110-1 and 110-2.

A main USB power supply line 24-1 extending from the connector pin 16-1 of the main USB connector 16 connects to an assist USB power supply line 26-1 extending from the connector pin 18-1 of the assist USB connector 18 at a point P1, and also connects to an assist power supply line 112-1 extending from the connector pin 110-1 of the DC jack 110 at a point P3. The common connection side connects to a connector pin 22-1 of the drive USB connector 22 through a USB power supply line 28-1.

Likewise, a USB ground line 24-4 extending from the connector pin 16-4 of the main USB connector 16, a USB ground line 26-4 extending from the connector pin 18-4 of the assist USB connector 18, and a USB ground line 112-2 extending from the connector pin 110-2 of the DC jack 110 are connected in common, and the common side connects to a connector pin 22-4 of the drive USB connector 22 through a USB ground line 28-4.

In the case where USB cables from a personal computer are connected to the main USB connector 16 and the assist USB connector 18 and where an AC adapter is connected to the DC jack 110, such a power supply current combining circuit provided in the power adapter 100 can supply a combined current generated from three power supply currents: power supply currents from the two USB ports and a power supply current from the AC adapter, to the storage subsystem on the load side from the drive USB connector 22.

Of course, USB interface signals can be mutually input/output by connecting the connector pins 16-2 and 16-3 of the main USB connector 16 to the connector pins 22-2 and 22-3 of the drive USB connector 22 through USB signal lines 24-2 and 24-3.

In the above-described three-input power adapter 100, assuming that the specifications of bus power by a USB connector are 5 volts/500 milliamperes, a sufficient current required for an operation of the storage subsystem, that is, the sum of a combined current of 5 volts/1000 milliamperes of bus powers from the two USB connectors and a current of 5 volts/500 milliamperes from the AC adapter, that is, 5 volts/1500 milliamperes in total, can be supplied from the power adapter 100.

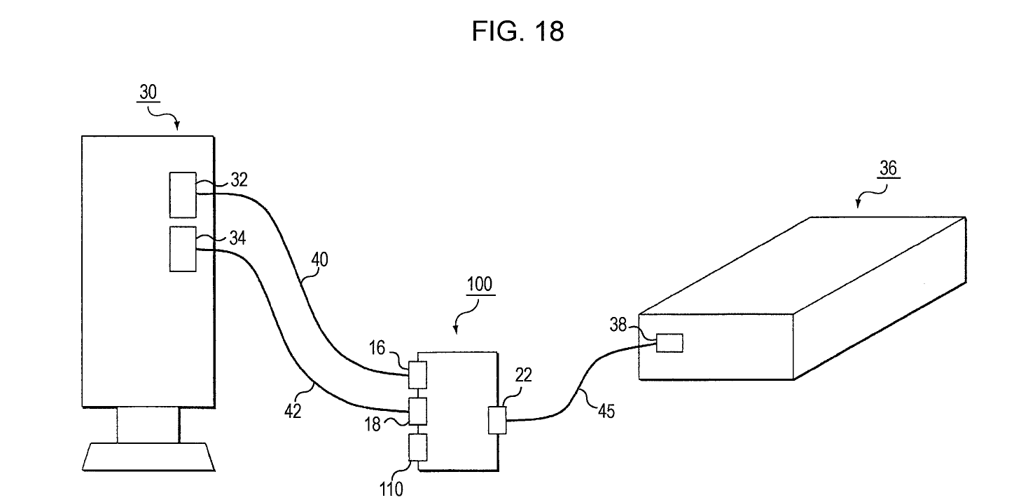

FIG. 18 is a diagram showing a connection state between a personal computer 30 and a storage subsystem 36 using the power adapter 100 shown in FIGS. 16A and 16B. Referring to FIG. 18, two USB connectors 32 and 34 of the personal computer 30 are connected to the main USB connector 16 and the assist USB connector 18 of the power adapter 100 by using two USB cables 40 and 42 so as to realize two-input power supply, and the DC jack 110 is not used. The drive USB connector 22 of the power adapter 100 is connected to a USB connector 38 of the storage subsystem 36 by using a USB cable 45.

As shown in FIG. 18, by using the three-input power adapter 100 as a two-input power adapter, power can be supplied to the storage subsystem 36 based on a combined current from the two USB connectors 32 and 34, as in the case shown in FIG. 5.

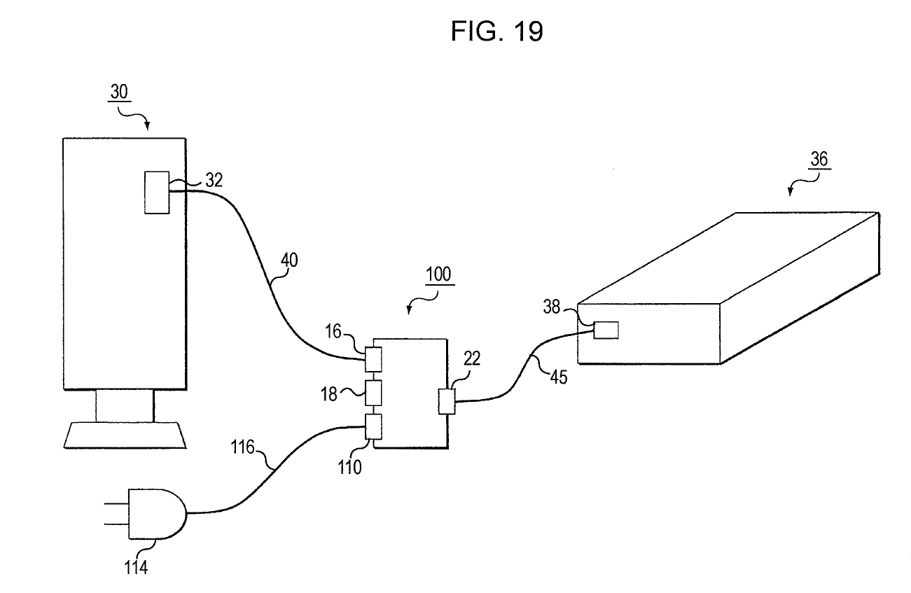

FIG. 19 is a diagram showing another connection status between the personal computer 30 and the storage subsystem 36 using the power adapter 100 shown in FIGS. 16A and 16B. Referring to FIG. 19, when only one USB port is provided in the personal computer 30, for example, the main USB connector 16 of the power adapter 100 is connected to the USB connector 32 of the personal computer 30 by using the USB cable 40.

Since bus power from one USB port supplied through the USB cable 40 is insufficient for an operating current of the storage subsystem 36, an AC adapter 114 is connected to the DC jack 110 of the power adapter 100 by using an adapter cable 116, so that a combined current generated from the bus power from the USB connector 32 and the DC power from the AC adapter 114 is supplied to the storage subsystem 36 via the USB connector 38 by using the USB cable 45 connected to the drive USB connector 22.

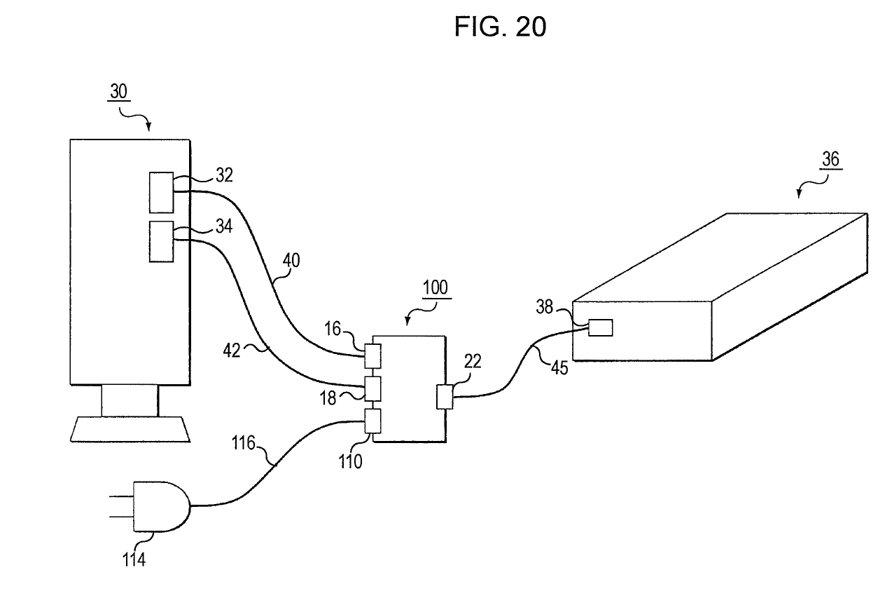

FIG. 20 is a diagram showing another connection state between the personal computer 30 and the storage subsystem 36 using the power adapter 100 shown in FIGS. 16A and 16B. Referring to FIG. 20, the personal computer 30 includes the two USB connectors 32 and 34, and thus those connectors are connected to the main USB connector 16 and the assist USB connector 18 of the power adapter 100 by using the USB cables 40 and 42 so that two USB bus powers are input.

Furthermore, the adapter cable 116 of the AC adapter 114 is connected to the DC jack 110 so as to supply DC power, and a three-input configuration is realized. In this case, a combined current of 5 volts/1500 milliamperes generated by combining bus powers from the two USB connectors 32 and 34 of the personal computer 30 with a DC power from the AC adapter 114 is supplied, so that a stable operation of the storage subsystem 36 can be ensured.

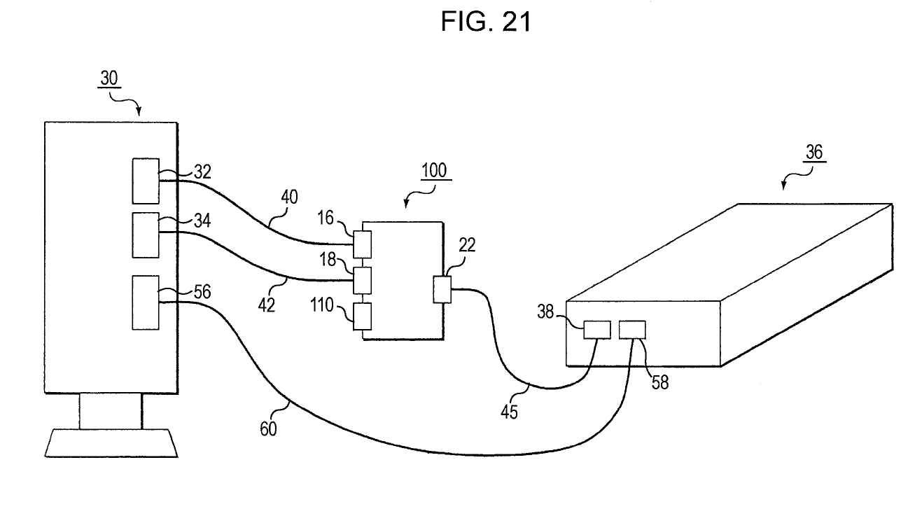

FIG. 21 is a diagram showing another connection state between the personal computer 30 and the storage subsystem 36 using the power adapter 100 shown in FIGS. 16A and 16B. Referring to FIG. 21, the personal computer 30 is connected to the storage subsystem 36 by using an e-SATA cable 60, and power is supplied to the storage subsystem 36 by using the power adapter 100.

The main USB connector 16 and the assist USB connector 18 of the power adapter 100 are connected to the USB connectors 32 and 34 of the personal computer 30 by using the USB cables 40 and 42, so that a combined current generated from the bus powers from the two USB connectors 32 and 34 is supplied to the storage subsystem 36 through the USB cable 45 connected to the drive USB connector 22 of the power adapter 100 via the USB connector 38.

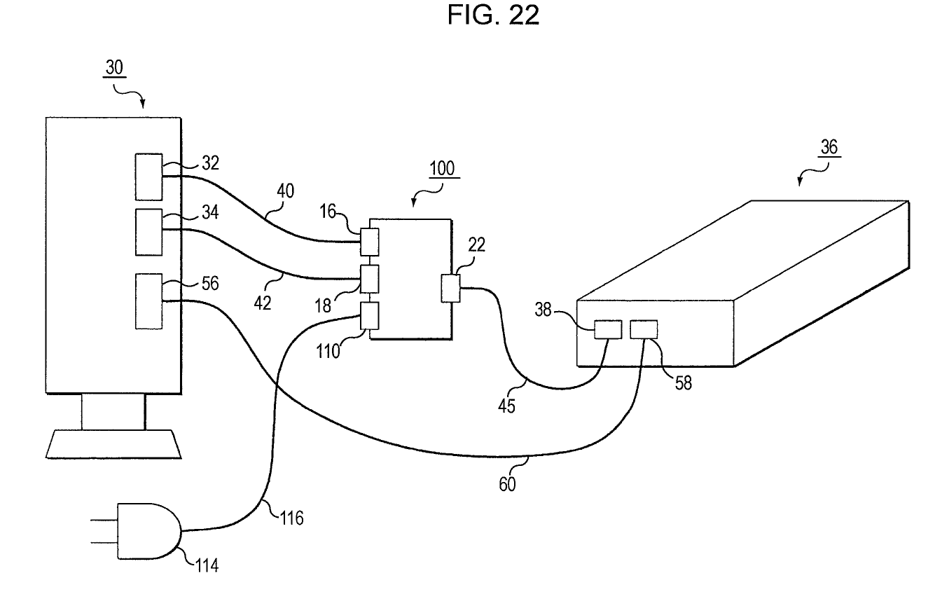

FIG. 22 is a diagram showing another connection state between the personal computer 30 and the storage subsystem 36 using the power adapter 100 shown in FIGS. 16A and 16B. Referring to FIG. 22, the AC adapter 114 is connected to the DC jack 110, which is not used in the power adapter 100 shown in FIG. 21, via the adapter cable 116, and three-input current combining of two USB powers and a DC power is performed.

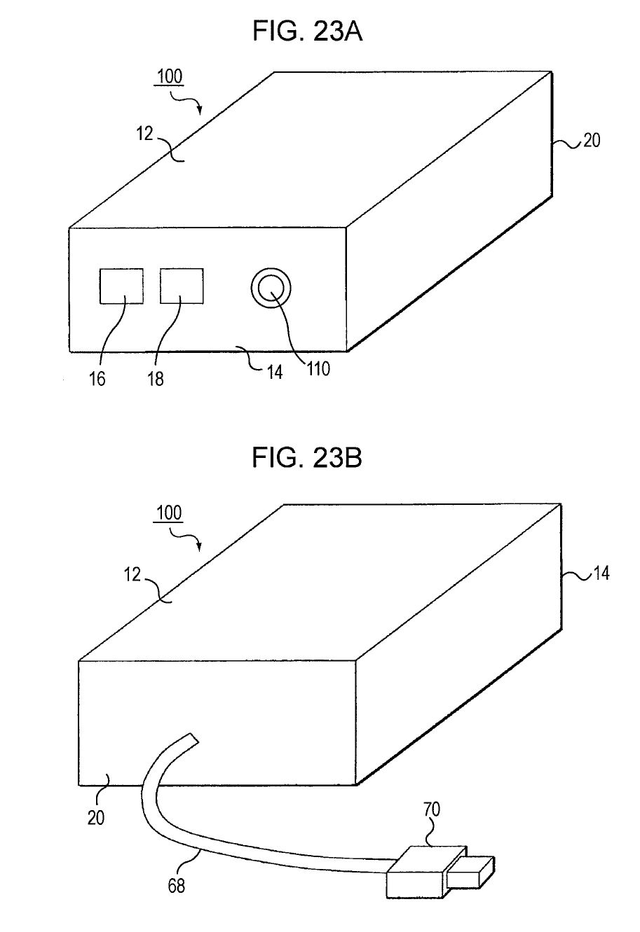

FIGS. 23A and 23B are diagrams showing another embodiment of the three-input power adapter according to the second technique of the embodiment. FIG. 23A shows the power adapter 100 viewed from the side of the front surface 14. As in FIG. 16A, the power adapter 100 has a three-input configuration including the main USB connector 16, the assist USB connector 18, and the DC jack 110.

On the side of the rear surface 20 shown in FIG. 23B, a USB cable 68 extends directly from the main body 12. A drive USB connector 70, which is a B-type male connector, for making connection with the storage subsystem 36 is connected at the end of the USB cable 68.

As described above, by providing the USB cable 68 extending directly from the main body 12 of the power adapter 100 and by connecting the drive USB connector 70 thereto, there is no need to provide the USB cable 45 as a dedicated cable for the side of the storage subsystem 36 in the connection states shown in FIGS. 18 to 22. Accordingly, a connecting operation can be simplified and the cost can be reduced.

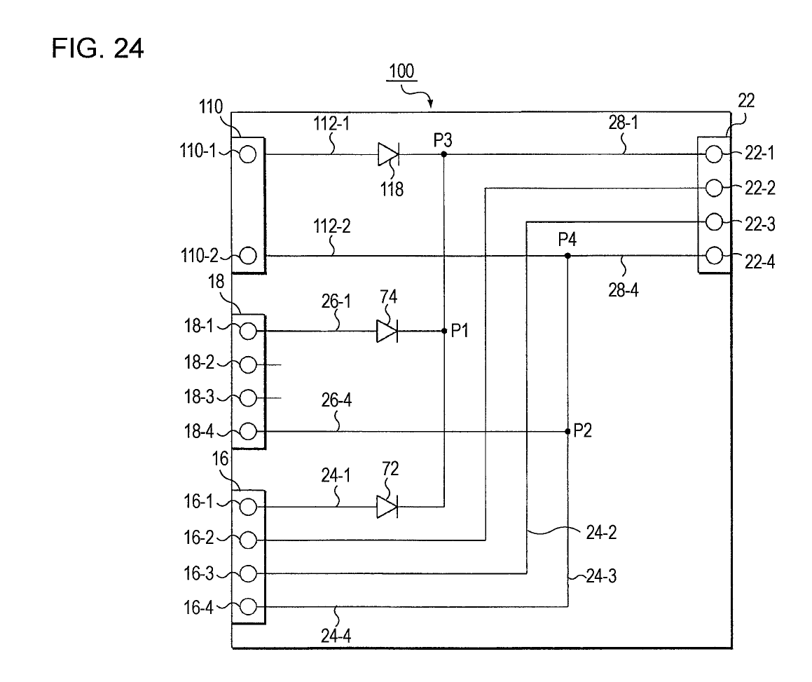

FIG. 24 is a circuit diagram showing another embodiment of the power supply current combining circuit included in the power adapter 100 shown in FIGS. 16A and 16B or FIGS. 23A and 23B. In the power adapter 100 shown in FIG. 24, the connection of power supply lines, ground lines, and signal lines among the main USB connector 16, the assist USB connector 18, the DC jack 110, and the drive USB connector 22 is the same as that in the embodiment shown in FIG. 17. Additionally, a diode 72 for preventing a reverse current is provided in the main USB power supply line 24-1 extending from the connector pin 16-1 of the main USB connector 16, a diode 74 for preventing a reverse current is provided in the assist USB power supply line 26-1 extending from the connector pin 18-1 of the assist USB connector 18, and furthermore, a diode 118 for preventing a reverse current is provided in the power supply line 112-1 extending from the connector pin 110-1 of the DC jack 110. The anode sides of the diodes 72, 74, and 118 are connected in common, and the common side connects to the connector pin 22-1 of the drive USB connector 22 through the USB power supply line 28-1.

As described above, by providing the diodes 72, 74, and 118 for preventing a reverse current in the three power supply lines on the input side, a reverse current to the USB connector of a lower voltage can be prevented and a reverse current preventing function set in the specifications of the USB interface can be effectively realized even if one of the power supply voltages of the USB connectors on the personal computer side connected to the main USB connector 16 and the assist USB connector 18 via USB cables becomes lower than the other voltage or a DC voltage from the DC jack 110.

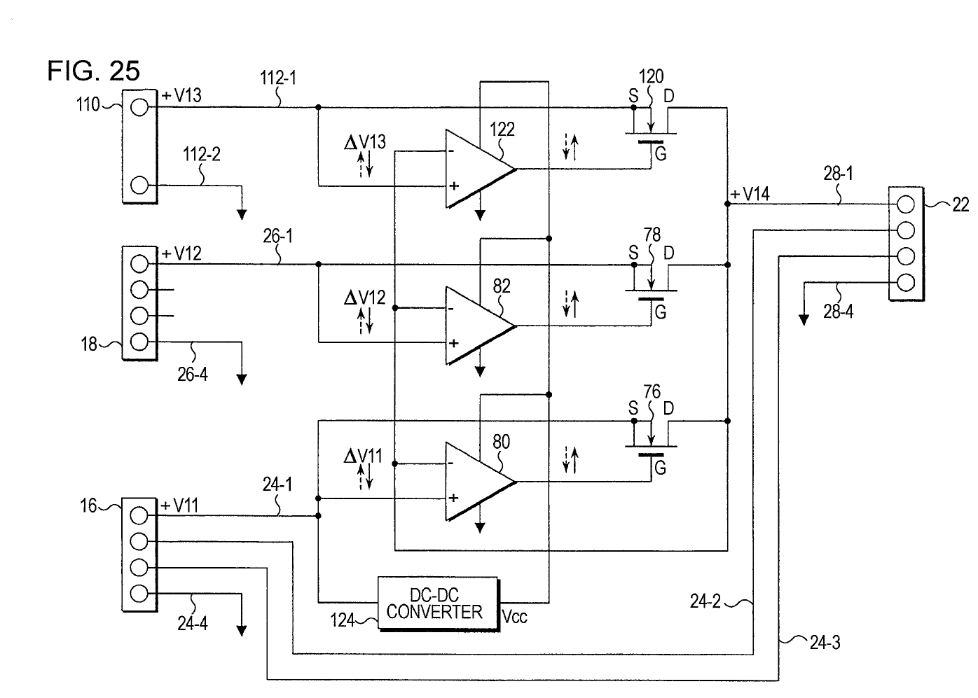

FIG. 25 is a circuit diagram showing another embodiment of the power supply current combining circuit included in the three-input combining power adapter according to the second technique of the embodiment shown in FIGS. 16A and 16B or FIGS. 23A and 23B. Referring to FIG. 25, an N-channel MOS-FET 76 is provided in the middle of the main USB power supply line 24-1 extending from the main USB connector 16, an N-channel MOS-FET 78 is provided in the middle of the assist USB power supply line 26-1 extending from the assist USB connector 18, and furthermore, an N-channel MOS-FET 120 is provided in the middle of the assist power supply line 112-1 extending from the DC jack 110 in this embodiment.

The N-channel MOS-FETs 76, 78, and 120 have sources S connected to the power input side and drains D connected to the power output side. The drain D sides are connected in common to the drive USB connector 22 through the USB power supply line 28-1.

On/off of the N-channel MOS-FETs 76, 78, and 120 is controlled by operational amplifiers 80, 82, and 122, respectively. The source S sides of the N-channel MOS-FETs 76, 78, and 120 connect to noninverting input terminals (+) on the input sides of the operational amplifiers 80, 82, and 122. Also, the drain D sides of the N-channel MOS-FETs 76, 78, and 120 connect to inverting input terminals (−) on the input sides of the operational amplifiers 80, 82, and 122. The output sides of the operational amplifiers 80, 82, and 122 connect to gates G of the N-channel MOS-FETs 76, 78, and 120.

Furthermore, a boosting DC-DC converter 124 is provided to generate operating power of the operational amplifiers 80, 82, and 122. The DC-DC converter 124 boosts a power supply voltage +V11 of 5 volts input through the main USB power supply line 24-1 of the main USB connector 16 to almost double (10 volts) in this embodiment, and supplies the boosted voltage as a power supply voltage Vcc to the operational amplifiers 80, 82, and 122.

The N-channel MOS-FETs 76, 78, and 120 provided in the main USB power supply line 24-1, the assist USB power supply line 26-1, and the assist power supply line 112-1 are brought into conduction in an on-state when a gate-source voltage Vgs is biased in the positive direction and are controlled to be turned off when the gate-source voltage Vgs is biased in the negative direction.

Here, assume that an input voltage of the main USB power supply line 24-1 is +V11, that an input voltage of the assist USB power supply line 26-1 is +V12, that an input voltage of the assist power supply line 112-1 of the DC jack 110 is +V13, and that a power supply voltage of the USB power supply line 28-1 to the load is +V14. In this case, the operational amplifiers 80, 82, and 122 perform on-control or off-control of the N-channel MOS-FETs 76, 78, and 122 in the following manner.

Now, assuming that the power supply voltage V11 of the main USB power supply line 24-1 is higher than the power supply voltage V14 on the load side, a voltage ΔV11=V11−V14 is input to the input side of the operational amplifier 80 with the polarity indicated by a solid-line arrow.

Accordingly, the output of the operational amplifier 80 is an inversion of the input, that is, a voltage having a positive-side potential indicated by a solid-line arrow. Thus, the N-channel MOS-FET 76 is controlled to be turned on, and the on-resistance thereof is very low, e.g., about 0.01Ω. At this time, the forward voltage drop is only 5 millivolts if a current supplied to the load is 500 milliamperes, and thus the power supply voltage V14 to the load can be maintained at a sufficient level.

When the N-channel MOS-FET 76 is controlled to be turned on and its inner resistance decreases in accordance with an increase to the positive side in the output of the operational amplifier 80, a differential voltage ΔV11 applied to the input is feedback-controlled to decrease, and the N-channel MOS-FET 76 is negative-feedback-controlled to an on-state with minimum on-resistance.

On the other hand, when the power supply voltage V11 of the main USB power supply line 24-1 is lower than the power supply voltage V14 on the output side, the differential voltage ΔV11 applied to the operational amplifier 80 is an input voltage in the positive direction indicated by a broken-line arrow. Thus, the output of the operational amplifier 80 decreases in the negative direction indicated by a broken-line arrow and controls the N-channel MOS-FET 76 to turn it off while causing its inner resistance to be H impedance, whereby a reverse direction characteristic of an ideal diode is realized.

Therefore, even if the power supply voltage V14 on the output side is higher than the power supply voltage V11 on the input side, a reverse current from the output side to the input side can be prevented by controlling the N-channel MOS-FET 76 to turn it off.

The above-described control of the N-channel MOS-FET 76 by the operational amplifier 80 can be applied to the control of the N-channel MOS-FET 78 provided in the assist USB power supply line 26-1 by the operational amplifier 82.

Now, assuming that the power supply voltage V12 of the assist USB power supply line 26-1 is higher than the power supply voltage V14 on the load side, a voltage ΔV12=V12−V14 is input to the input side of the operational amplifier 82 with the polarity indicated by a solid-line arrow.

Thus, the output of the operational amplifier 82 is a voltage having a positive-side potential indicated by a solid-line arrow, so that the N-channel MOS-FET 78 is controlled to be turned on. When the N-channel MOS-FET 78 is controlled to be turned on and its inner resistance decreases in accordance with an increase to the positive side in the output of the operational amplifier 82, a differential voltage ΔV12 applied to the input is feedback-controlled to decrease, and the N-channel MOS-FET 78 is negative-feedback-controlled to an on-state with minimum on-resistance.

On the other hand, when the power supply voltage V12 of the assist USB power supply line 26-1 is lower than the power supply voltage V14 on the output side, the differential voltage ΔV12 applied to the operational amplifier 82 is an input voltage in the positive direction indicated by a broken-line arrow. Thus, the output of the operational amplifier 82 decreases in the negative direction indicated by a broken-line arrow and controls the N-channel MOS-FET 78 to turn it off while causing its inner resistance to be H impedance, whereby a reverse direction characteristic of an ideal diode is realized.

Furthermore, the above-described control of the N-channel MOS-FET 76 by the operational amplifier 80 can be applied to the control of the N-channel MOS-FET 120 provided in the assist power supply line 112-1 by the operational amplifier 122.

Now, assuming that the power supply voltage V13 of the assist power supply line 112-1 is higher than the power supply voltage V14 on the load side, a voltage ΔV13=V13−V14 is input to the input side of the operational amplifier 122 with the polarity indicated by a solid-line arrow.

Thus, the output of the operational amplifier 122 is a voltage having a positive-side potential indicated by a solid-line arrow, so that the N-channel MOS-FET 120 is controlled to be turned on. When the N-channel MOS-FET 120 is controlled to be turned on and its inner resistance decreases in accordance with an increase to the positive side in the output of the operational amplifier 122, a differential voltage ΔV13 applied to the input is feedback-controlled to decrease, and the N-channel MOS-FET 120 is negative-feedback-controlled to an on-state with minimum on-resistance.

On the other hand, when the power supply voltage V13 of the assist power supply line 112-1 is lower than the power supply voltage V14 on the output side, the differential voltage ΔV13 applied to the operational amplifier 122 is an input voltage in the positive direction indicated by a broken-line arrow. Thus, the output of the operational amplifier 122 decreases in the negative direction indicated by a broken-line arrow and controls the N-channel MOS-FET 120 to turn it off while causing its inner resistance to be H impedance, whereby a reverse direction characteristic of an ideal diode is realized.

In this case, each of the input voltages V11, V12, and V13 of the operational amplifiers 80, 82, and 122 is 5 volts. Since the operational amplifiers 80, 82, and 122 need to change an output voltage with a threshold of 5 volts, almost double of the threshold 5 volts, that is, 10 volts is necessary as the power supply voltage Vcc, which is generated by the DC-DC converter 124.

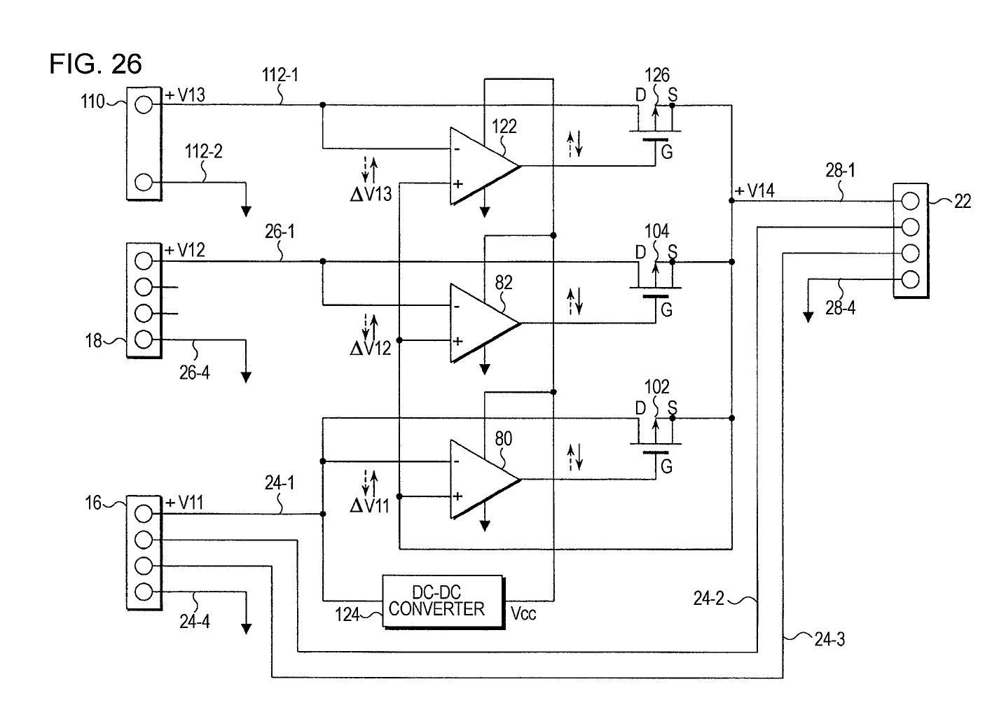

FIG. 26 is a circuit diagram showing another embodiment of the power supply current combining circuit included in the three-input combining power adapter according to the second technique of the embodiment shown in FIGS. 16A and 16B or FIGS. 23A and 23B. This embodiment is characterized in that P-channel MOS-FETs are used.

Referring to FIG. 26, P-channel MOS-FETs 102, 104, and 126 are provided in the middle of the main USB power supply line 24-1 extending from the main USB connector 16, the assist USB power supply line 26-1 extending from the assist USB connector 18, and the assist power supply one 112-1 extending from the DC jack 110, respectively, in this embodiment. That is, drains D of the P-channel MOS-FETs 102, 104, and 126 connect to the power input side, whereas sources S connect in common to the USB power supply line 28-1 on the output side.

On/off of the P-channel MOS-FETs 102, 104, and 126 is controlled by the operational amplifiers 80, 82, and 122. Gate-drain voltages Vgd of the P-channel MOS-FETs 102, 104, and 126 are input to the operational amplifiers 80, 82, and 122. That is, the sources S of the P-channel MOS-FETs 102, 104, and 126 connect to the noninverting input terminals (+) on the input side of the operational amplifiers 80, 82, and 122. Also, the drains D thereof connect to the inverting input terminals (−) on the input side.

The P-channel MOS-FETs 102, 104, and 126 are controlled to be turned on when the gate-drain voltage is biased in the negative direction as indicated by a solid-line arrow and are controlled to be turned off when the gate-drain voltage is biased in the positive direction as indicated by a broken-line arrow.

To the input side of the operational amplifier 80, a differential voltage ΔV11=V11−V14 between the power supply voltage V11 of the main USB power supply line 24-1 and the power supply voltage V14 of the USB power supply line 28-1 on the output side is input. On the other hand, to the operational amplifier 82, a differential voltage ΔV12=V12−V14 between the power supply voltage V12 of the assist USB power supply line 26-1 and the power supply voltage V14 of the USB power supply line 28-1 on the output side is input.

Furthermore, to the operational amplifier 122, a differential voltage ΔV13=V13−V14 between the power supply voltage V13 of the assist USB power supply line 112-1 and the power supply voltage V14 of the USB power supply line 28-1 on the output side is input.

For example, control of the P-channel MOS-FET 102 by the operational amplifier 80 is described. When the power supply voltage V11 of the main USB power supply line 24-1 is higher than the power supply voltage V14 on the output side, the differential voltage ΔV11 input to the operational amplifier 80 has a polarity indicated by a solid-line arrow. In this case, the output of the operational amplifier 80 is a voltage changing in the negative direction indicated by a solid-line arrow and controls the P-channel MOS-FET 102 to turn it on.

When the P-channel MOS-FET 102 is controlled to be turned on, the on-resistance thereof is about 0.01Ω, for example. Accordingly, a forward voltage drop is only 0.05 millivolts with respect to a typical maximum current of 500 milliamperes of the USB interface.

On the other hand, when the power supply voltage V14 on the output side is higher than the power supply voltage V11 on the input side, the differential voltage ΔV11 input to the operational amplifier 80 has a polarity indicated by a broken-line arrow. In this case, the output of the operational amplifier 80 increases in the positive direction as indicated by a broken-line arrow. Accordingly, the P-channel MOS-FET 102 is controlled to be turned off, a reverse direction characteristic of an ideal diode is realized, and a reverse current from the higher power supply voltage V14 to the lower power supply voltage V11 can be realizably prevented.

The control to turn on/off the P-channel MOS-FET 104 provided in the assist USB power supply line 26-1 by the operational amplifier 82, and the control to turn on/off the P-channel MOS-FET 126 provided in the assist power supply line 112-1 by the operational amplifier 122 are the same as in the case of the operational amplifier 80.

The P-channel MOS-FETs 102, 104, and 126 can be controlled to be turned on by changing the output in the negative direction by the operational amplifiers 80, 82, and 122. Thus, when the threshold of the operational amplifiers 80, 82, and 122 is 5 volts corresponding to the input voltages V11, V12, and V13, the output may be biased to 5 volts or lower for on-control.

On the other hand, for off-control, the output of the operational amplifiers 80, 82, and 122 is increased to the positive side from the threshold 5 volts. In the bias to the positive side in this case, the voltage may be increased by about 2 to 3 volts from the threshold 5 volts.

Therefore, in the embodiment shown in FIG. 26, the power supply voltage Vcc supplied from the DC-DC converter 124 to the operational amplifiers 80, 82, and 122 may be about 7 to 8 volts. Thus, a smaller and less expensive DC-DC converter can be used as the DC-DC converter 124 compared to the case in the embodiment shown in FIG. 25, where the power supply voltage Vcc for the operational amplifiers 80, 82, and 122 needs to be 10 volts.

Of course, the voltage doubler circuit 84 shown in FIG. 13 may be used instead of the DC-DC converter 124 shown in FIGS. 25 and 26.

### Embodiment of Third Technique

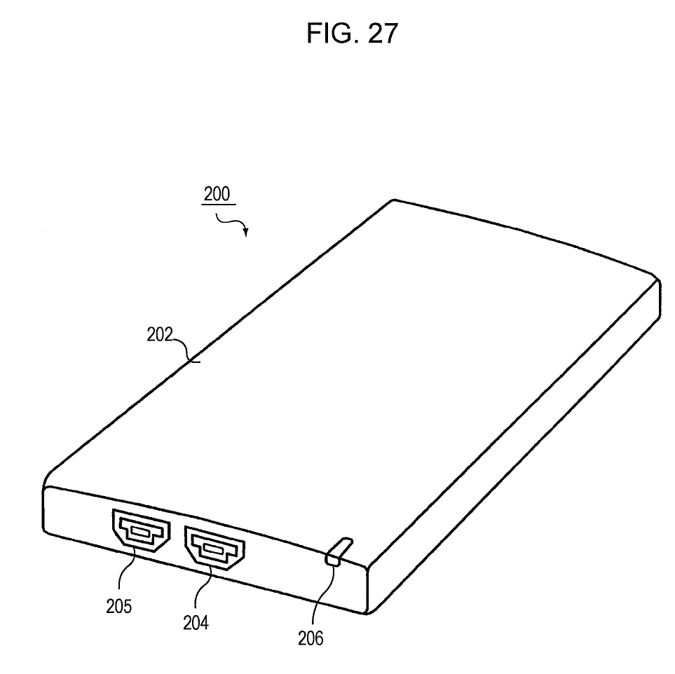

FIG. 27 is a diagram showing a hard disk subsystem as an embodiment of a storage apparatus according to a third technique of the embodiment. Referring to FIG. 27, a portable hard disk subsystem 200 as an embodiment of a storage apparatus according to the third technique of the embodiment has a palm-sized and book-shaped case 202 having a thickness of about 15 to 20 mm, and a main USB connector 204 and an assist USB connector 205 used as a power supply assist are provided on a front surface of the case 202, as in the embodiment shown in FIGS. 1A and 1B. Furthermore, an LED indicator 206 is provided.

A USB cable extending from an external apparatus, such as a personal computer, is connected to the USB connector 204. Also, an assist USB cable including only a VBUS line and a ground line extending from the external apparatus, such as a personal computer, is connected to the assist USB connector 205 so that only bus power of a USB interface is supplied.

In this embodiment, upon connection of a USB cable extending from an external apparatus, such as a personal computer, to the main USB connector 204, power is supplied to the hard disk subsystem 200, so that the hard disk subsystem 200 is activated. However, a stable operation is not realized only by supplying bus power through cable connection to the main USB connector 204. Thus, in principle, another USB port of the personal computer is connected to the assist USB connector 205 by using an assist USB cable in order to supply power, and currents from the two ports are added in the case 202, whereby power is supplied to a hard disk drive as a load.

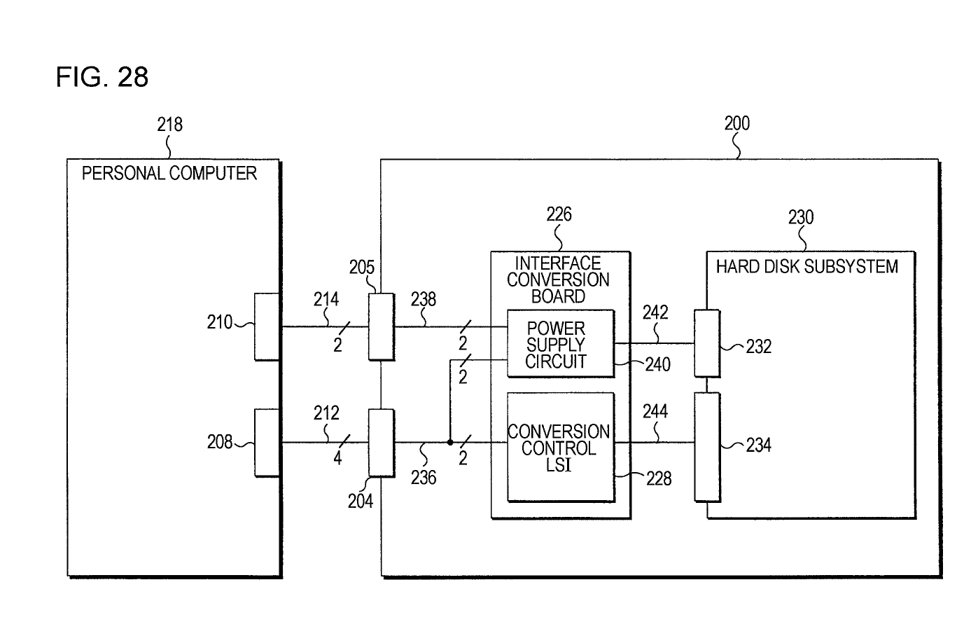

FIG. 28 is a block diagram showing the internal configuration of the hard disk subsystem according to the embodiment of the third technique. Referring to FIG. 28, the hard disk subsystem 200 is provided with an interface conversion board 226 and a hard disk drive 230 functioning as a storage device. On the interface conversion board 226, a conversion control LSI 228 and a power supply circuit 240 are mounted.

In this embodiment, a SATA interface is used as a device interface of the hard disk drive 230. In order to perform signal conversion between the SATA interface and a USB interface of a personal computer 218, the conversion control LSI 228 performs mutual signal conversion between the USB interface and the SATA interface.

As the conversion control LSI 228, INIC-1605 as a USB-to-SATA bridge made by Initio Corporation can be used, for example.

A USB cable 212 extending from a USB connector 208 of the personal computer 218 is connected to the main USB connector 204 provided in the hard disk subsystem 200. The USB cable 212 includes four signal lines. Two of those signal lines are a USB power supply line and a ground line, which typically supply a bus power of 5 volts/500 milliamperes. The other two are a pair of signal lines known as D+ and D−.

On the other hand, an assist USB cable 214 extending from another USB connector 210 of the personal computer 218 is connected to the assist USB connector 205 provided in the hard disk subsystem 200. The assist USB cable 214 includes only a VBUS line and a ground line and is connected to supply assist bus power.

Among the lines included in a USB interface transmission path 236 extending from the main USB connector 204, two lines as a USB power supply line and a ground line are connected to the power supply circuit 240 provided on the interface conversion board 226, and the other lines as signal lines are connected to the conversion control LSI 228. On the other hand, an assist USB power supply line 238 extending from the assist USB connector 205 is connected to the power supply circuit 240 provided on the interface conversion board 226.

The power supply circuit 240 adds currents of bus powers from two ports having the USB connectors 208 and 210 of the personal computer 218, outputs power through an output power supply line 242, and supplies USB bus power to the hard disk drive 230 via a power supply connector 232. The conversion control LSI 228 is connected to the hard disk drive 230 through a SATA interface transmission path 244 via a SATA connector 234.

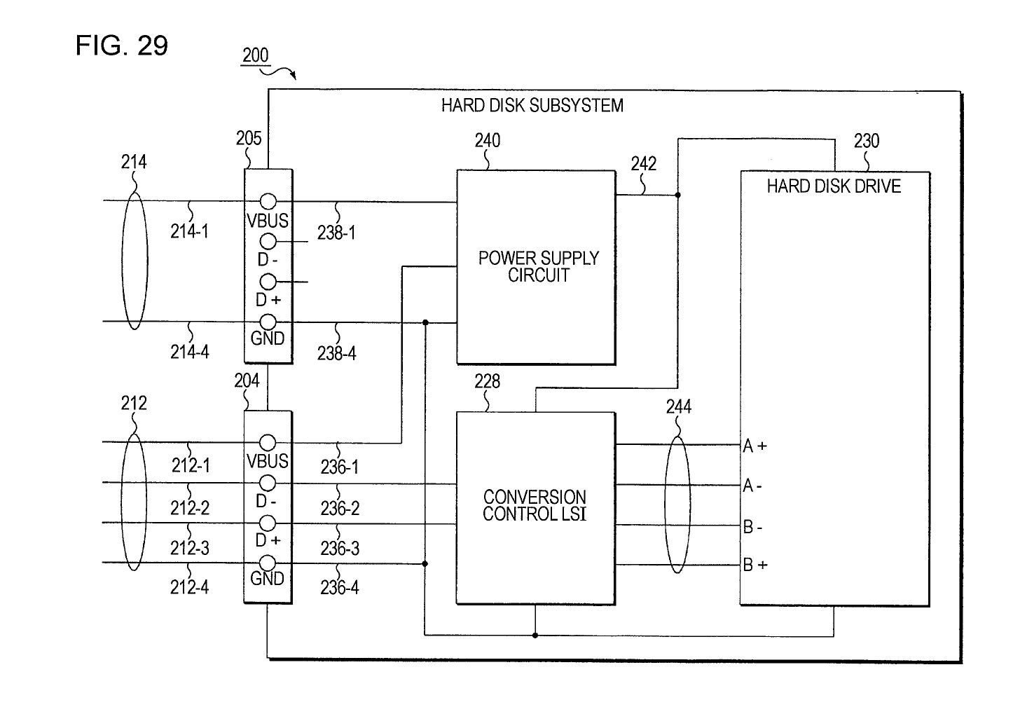

FIG. 29 is a block diagram showing the circuit function of the hard disk subsystem 200 according to the embodiment of the third technique. Referring to FIG. 29, the main USB connector 204 provided in the hard disk subsystem 200 includes four connector pins denoted by VBUS, D−, D+, and GND, which connect to a USB line 212-1, USB signal lines 212-2 and 212-3, and a USB ground line 212-4 of the USB cable 212 and also connect to a main USB power supply line 236-1, USB signal lines 236-2 and 236-3, and a ground line 236-4 that extend from the main USB connector 204 to the inside of the hard disk subsystem 200. The USB power supply line 236-1 and the USB ground line 236-4 extending from the main USB connector 204 connect to the power supply circuit 240.

The assist USB connector 205 includes four connector pins denoted by VBUS, D−, D+, and GND, as the main USB connector 204, and is supplied with power by being connected to a USB port on the personal computer side through an assist USB power supply line 214-1 and an assist USB ground line 214-4 of the assist USB cable 214.

An assist USB power supply line 238-1 and an assist USB ground line 238-4 extend from the assist USB connector 205 and connect to the power supply circuit 240. The output power supply line 242 extends from the power supply circuit 240, connects to the hard disk drive 230 and the conversion control LSI 228, and supplies bus power.

The conversion control LSI 228 to perform USB-SATA conversion connects to the hard disk drive 230 through a SATA interface transmission path 244. As shown in the figure, the SATA interface transmission path 244 includes four signal lines: uplink transmission lines denoted by A+ and A−; and downlink transmission lines denoted by B− and B+.

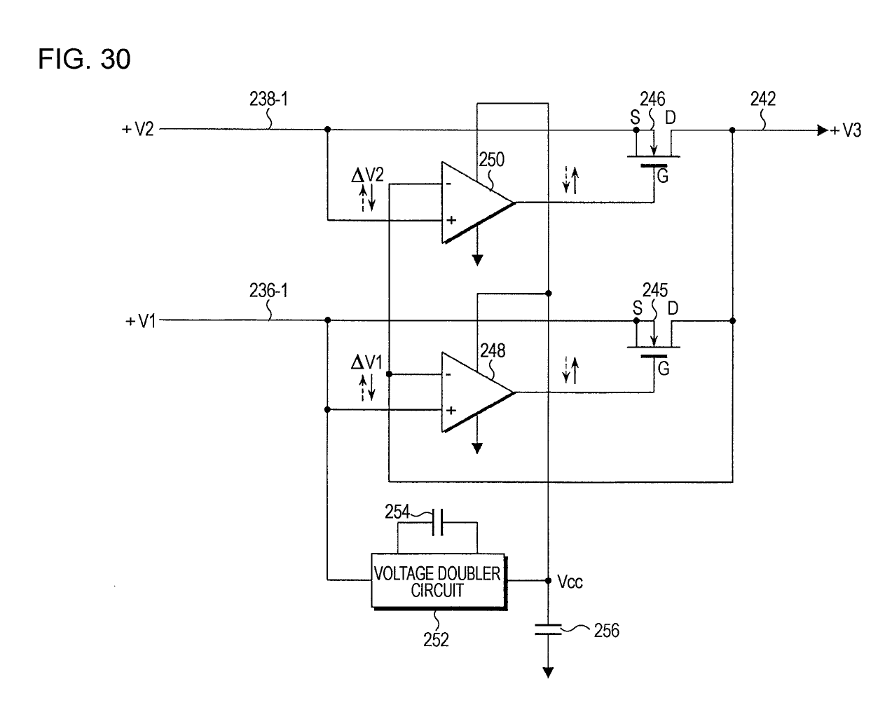

FIG. 30 is a circuit diagram showing an embodiment of the power supply circuit 240 shown in FIG. 29. Referring to FIG. 30, an N-channel MOS-FET 245 is provided in the middle of the main USB power supply line 236-1 on the signal side, and an N-channel MOS-FET 246 is provided in the middle of the assist USB power supply line 238-1 in this embodiment.

The N-channel MOS-FETs 245 and 246 have sources S connected to the power input side and drains D connected to the power output side. The drain D sides are connected in common to an output power supply line 242 that connects to the side of the hard disk driver 230.

On/off of the N-channel MOS-FETs 245 and 246 is controlled by operational amplifiers 248 and 250, respectively. The source S sides of the N-channel MOS-FETs 245 and 246 connect to noninverting input terminals (+) on the input sides of the operational amplifiers 248 and 250. Also, the drain D sides of the N-channel MOS-FETs 245 and 246 connect to inverting input terminals (−) on the input sides of the operational amplifiers 248 and 250. The output sides of the operational amplifiers 248 and 250 connect to gates G of the N-channel MOS-FETs 245 and 246.

Furthermore, a voltage doubler circuit 252 is provided to generate operating power of the operational amplifiers 248 and 250. The voltage doubler circuit 252 boosts a power supply voltage +V1 of 5 volts input through the main USB power supply line 236-1 to almost double (10 volts) in this embodiment by a switched capacitor operation using externally-connected capacitors 254 and 256, and supplies the boosted voltage as a power supply voltage Vcc to the operational amplifiers 248 and 250.

The N-channel MOS-FETs 245 and 246 provided in the main USB power supply line 236-1 and the assist USB power supply line 238-1 are brought into conduction in an on-state when a gate-source voltage Vgs is biased in the positive direction and are controlled to be turned off when the gate-source voltage Vgs is biased in the negative direction.

Here, assume that an input voltage of the main USB power supply line 236-1 is +V1, that an input voltage of the assist USB power supply line 238-1 is +V2, and that a power supply voltage of the output power supply line 242 to the load is +V3. In this case, the operational amplifiers 248 and 250 perform on-control or off-control of the N-channel MOS-FETs 245 and 246 in the following manner.

Now, assuming that the power supply voltage V1 of the main USB power supply line 236-1 is higher than the power supply voltage V3 on the load side, a voltage ΔV1=V1−V3 is input to the input side of the operational amplifier 248 with the polarity indicated by a solid-line arrow.

Accordingly, the output of the operational amplifier 248 is inversion of the input, that is, a voltage having a positive-side potential indicated by a solid-line arrow. Thus, the N-channel MOS-FET 245 is controlled to be turned on, and the on-resistance thereof is very low, e.g., about 0.01Ω. At this time, the forward voltage drop is only 5 millivolts if a current supplied to the load is 500 milliamperes, and thus the power supply voltage V3 to the load can be maintained at a sufficient level.

When the N-channel MOS-FET 245 is controlled to be turned on and its inner resistance decreases in accordance with an increase to the positive side in the output of the operational amplifier 248, a differential voltage ΔV1 applied to the input is feedback-controlled to decrease, and the N-channel MOS-FET 245 is negative-feedback-controlled to an on-state with minimum on-resistance.

On the other hand, when the power supply voltage V1 of the main USB power supply line 236-1 is lower than the power supply voltage V3 on the output side, the differential voltage ΔV1 applied to the operational amplifier 248 is an input voltage in the positive direction indicated by a broken-line arrow. Thus, the output of the operational amplifier 248 decreases in the negative direction indicated by a broken-line arrow and controls the N-channel MOS-FET 245 to turn it off while causing its inner resistance to be H impedance, whereby a reverse direction characteristic of an ideal diode is realized.

Therefore, even if the power supply voltage V3 on the output side is higher than the power supply voltage V1 on the input side, a reverse current from the output side to the input side can be prevented by controlling the N-channel MOS-FET 245 to turn it off.

The above-described control of the N-channel MOS-FET 245 by the operational amplifier 248 can be applied to the control of the N-channel MOS-FET 246 provided in the assist USB power supply line 238-1 by the operational amplifier 250.

Now, assuming that the power supply voltage V2 of the assist USB power supply line 238-1 is higher than the power supply voltage V3 on the load side, a voltage ΔV2=V2−V3 is input to the input side of the operational amplifier 250 with the polarity indicated by a solid-line arrow.

Thus, the output of the operational amplifier 250 is a voltage having a positive-side potential indicated by a solid-line arrow, so that the N-channel MOS-FET 246 is controlled to be turned on. When the N-channel MOS-FET 246 is controlled to be turned on and its inner resistance decreases in accordance with an increase to the positive side in the output of the operational amplifier 250, a differential voltage ΔV2 applied to the input is feedback-controlled to decrease, and the N-channel MOS-FET 246 is negative-feedback-controlled to an on-state with minimum on-resistance.

On the other hand, when the power supply voltage V2 of the assist USB power supply line 238-1 is lower than the power supply voltage V3 on the output side, the differential voltage ΔV2 applied to the operational amplifier 250 is an input voltage in the positive direction indicated by a broken-line arrow. Thus, the output of the operational amplifier 250 decreases in the negative direction indicated by a broken-line arrow and controls the N-channel MOS-FET 246 to turn it off while causing its inner resistance to be H impedance, whereby a reverse direction characteristic of an ideal diode is realized.

In this case, each of the input voltages V1 and V2 of the operational amplifiers 248 and 250 is 5 volts. Since the operational amplifiers 248 and 250 need to change an output voltage with a threshold of 5 volts, almost double of the threshold 5 volts, that is, 10 volts is necessary as the power supply voltage Vcc, which is generated by the voltage doubler circuit 252.

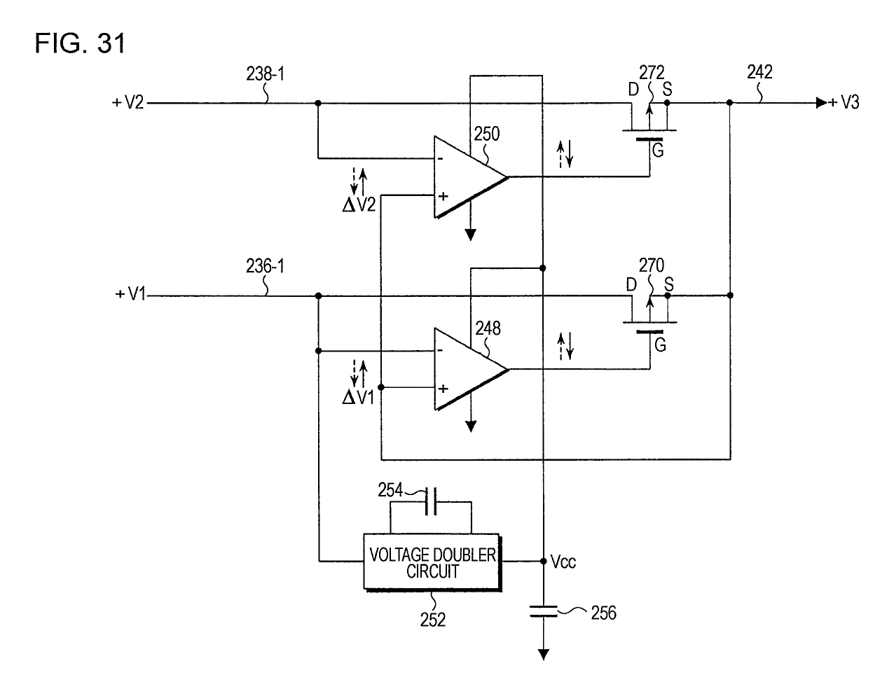

FIG. 31 is a circuit diagram showing another embodiment of the power supply circuit 240 shown in FIG. 29. This embodiment is characterized in that P-channel MOS-FETs are used.

Referring to FIG. 31, P-channel MOS-FETs 270 and 272 are provided in the middle of the main USB power supply line 236-1 and the assist USB power supply line 238-1, respectively, in this embodiment. That is, drains D of the P-channel MOS-FETs 270 and 272 connect to the power input side, whereas sources S connect in common to the side of the output power supply line 242.

On/off of the P-channel MOS-FETs 270 and 272 is controlled by the operational amplifiers 248 and 250. Gate-drain voltages Vgd of the P-channel MOS-FETs 270 and 272 are input to the operational amplifiers 248 and 250. That is, the sources S of the P-channel MOS-FETs 270 and 272 connect to the noninverting input terminals (+) on the input side of the operational amplifiers 248 and 250. Also, the drains D thereof connect to the inverting input terminals (−) on the input side.

The P-channel MOS-FETs 270 and 272 are controlled to be turned on when the gate-drain voltage is biased in the negative direction as indicated by a solid-line arrow and are controlled to be turned off when the gate-drain voltage is biased in the positive direction as indicated by a broken-line arrow.

To the input side of the operational amplifier 248, a differential voltage ΔV1=V1−V3 between the power supply voltage V1 of the main USB power supply line 236-1 and the power supply voltage V3 of the output power supply line 242 is input. On the other hand, to the operational amplifier 250, a differential voltage ΔV2=V2−V3 between the power supply voltage V2 of the assist USB power supply line 238-1 and the power supply voltage V3 of the output power supply line 242 is input.

For example, control of the P-channel MOS-FET 270 by the operational amplifier 248 is described. When the power supply voltage V1 of the main USB power supply line 236-1 is higher than the power supply voltage V3 on the output side, the differential voltage ΔV input to the operational amplifier 248 has a polarity indicated by a solid-line arrow. In this case, the output of the operational amplifier 248 is a voltage changing in the negative direction indicated by a solid-line arrow and controls the P-channel MOS-FET 270 to turn it on.

When the P-channel MOS-FET 270 is controlled to be turned on, the on-resistance thereof is about 0.01Ω, for example. Accordingly, a forward voltage drop is only 0.05 millivolts with respect to a typical maximum current of 500 milliamperes of the USB interface.

On the other hand, when the power supply voltage V3 on the output side is higher than the power supply voltage V1 on the input side, the differential voltage ΔV1 input to the operational amplifier 248 has a polarity indicated by a broken-line arrow. In this case, the output of the operational amplifier 248 increases in the positive direction as indicated by a broken-line arrow. Accordingly, the P-channel MOS-FET 270 is controlled to be turned off, a reverse direction characteristic of an ideal diode is realized, and a reverse current from the higher power supply voltage V3 to the lower power supply voltage V1 can be realizably prevented.

The control to turn on/off the P-channel MOS-FET 272 provided in the assist USB power supply line 238-1 by the operational amplifier 250 is the same as in the case of the operational amplifier 248.

The P-channel MOS-FETs 270 and 272 can be controlled to be turned on by changing the output in the negative direction by the operational amplifiers 248 and 250. Thus, when the threshold of the operational amplifiers 248 and 250 is 5 volts corresponding to the input voltages V1 and V2, the output may be biased to 5 volts or lower for on-control.

On the other hand, for off-control, the output of the operational amplifiers 248 and 250 is increased to the positive side from the threshold 5 volts. In the bias to the positive side in this case, the voltage may be increased by about 2 to 3 volts from the threshold 5 volts.

Therefore, in the embodiment shown in FIG. 31, the power supply voltage Vcc supplied from the voltage doubler circuit 252 to the operational amplifiers 248 and 250 may be about 7 to 8 volts. Thus, a smaller and less expensive voltage doubler circuit can be used as the voltage doubler circuit 252 compared to the case in the embodiment shown in FIG. 30 where the power supply voltage Vcc for the operational amplifiers 248 and 250 need to be 10 volts.

Of course, in the embodiment shown in FIG. 31, too, a boosting DC-DC converter can be used instead of the voltage doubler circuit 252. In that case, a boosted voltage may be 7 to 8 volts. Therefore, a smaller and less expensive DC-DC converter can be advantageously used compared to the embodiment shown in FIG. 30 where the boosted voltage is 10 volts.

In the above-described embodiment, the case where a hard disk drive is included as the storage subsystem has been used as an example. Alternatively, an appropriate input/output drive such as an optical disc drive may be of course used.

The conversion printed board 46 of the storage subsystem 36 shown in FIG. 4 performs USB/ATA interface conversion, for example. Alternatively, USB/SATA interface conversion may be performed. For the interface conversion, USB 2.0 SATA Bridge INIC-1605 made by Initio Corporation may be used, for example.

The present techniques include appropriate modifications that do not damage the purposes and advantages thereof, and are not limited by numerical values described in the above embodiments.

### Advantages of First and Second Techniques

According to the first technique of the embodiment, currents of bus powers supplied through two USB cables connected to a host apparatus are combined in the power adapter and the combined current is supplied to the load side in two-input combining of USB powers. Accordingly, even if a storage apparatus has a single USB port, a sufficient operating current can be supplied to the storage apparatus, lack of operating current of USB bus power can be overcome, and the externally-connected storage apparatus can be stably operated by using the USB bus power.

According to the second technique of the embodiment, currents from three inputs: two inputs of USB bus powers and a power from an AC adapter, are combined to obtain an operating current for the storage apparatus that requires a current larger than a combined current of two inputs of USB bus powers, so that a stable operation can be ensured.

Furthermore, MOS-FETs are provided in the middle of the respective power supply lines that are connected in common in order to combine currents of two inputs or three inputs, and operational amplifiers control on/off in accordance with a potential difference between the power input side and the power output side of the MOS-FETs. Accordingly, when on-control is performed, on-resistance of the MOS-FETs is very low, 0.01Ω, for example, and the forward voltage drop of a USB bus power having typical specifications of 5 volts/500 milliamperes is only 5 millivolts. Accordingly, a drop in voltage when currents from two USB ports are added can be minimized and the operation of the load can be stabilized.

When the MOS-FETs are controlled to be turned off by the operational amplifiers, a characteristic of an ideal diode can be obtained in a reverse direction, and a reverse current between two USB ports can be reliably prevented.

### Advantages of Third Technique

According to the third technique of the embodiment, MOS-FETs are provided in the middle of the respective power supply lines that are connected in common in order to combine currents from two USB ports in the storage apparatus, and operational amplifiers control MOS-FET on/off in accordance with a potential difference between the power input side and the power output side of the MOS-FETs. Accordingly, when on-control is performed, on-resistance of the MOS-FETs is very low, 0.01Ω, for example, and the forward voltage drop of a USB bus power having typical specifications of 5 volts/500 milliamperes is only 5 millivolts. Accordingly, a drop in voltage when currents from two USB ports are added can be minimized and the operation of the load can be stabilized.

When the MOS-FETs are controlled to be turned off by the operational amplifiers, a characteristic of an ideal diode can be obtained in a reverse direction, and a reverse current between two USB ports can be reliably prevented.

The order in which the embodiments were described is not a showing of superiority of one embodiment over another. Although the embodiments of the present inventions has been described in detail, it should be understood that the various changes, substitutions, and alterations could be made hereto without departing from the spirit and scope of the invention.

What is claimed is:

1. A power adapter to connect a host apparatus to an external storage apparatus through USB cables via connectors, the power adapter comprising:
a main USB connector that includes a power supply terminal, a ground terminal, and a pair of signal terminals and that is externally connected to a main USB cable extending from the host apparatus;
an assist USB connector that includes a power supply terminal, a ground terminal, and a pair of signal terminals and that is externally connected to an assist USB cable extending from the host apparatus;
a drive USB connector that includes a power supply terminal, a ground terminal, and a pair of signal terminals and that is externally connected to a USB cable extending from the storage apparatus; and
a power supply current combining circuit that combines a current from the power supply terminal of the main USB connector and a current from the power supply terminal of the assist USB connector so as to output a combined current to the power supply terminal of the drive USB connector and that mutually inputs/outputs signals between the signal terminals of the main USB connector and the signal terminals of the drive USB connector.

2. The power adapter according to claim 1, wherein the main USB connector and the assist USB connector are B-type USB female connectors or mini-B-type USB female connectors, and wherein the drive USB connector is an A-type USB connector.

3. The power adapter according to claim 1, wherein the main USB connector and the assist USB connector are B-type USB female connectors or mini-B-type USB female connectors, and wherein the drive USB connector is a B-type USB female connector or a mini-B-type USB female connector connected to a USB cable extending from the inside of the adapter to the outside.

4. The power adapter according to claim 1, wherein, in the power supply current combining circuit, a power supply line and a ground line extending from the main USB connector connect to a power supply line and a ground line extending from the assist USB connector, respectively, so as to be combined into common lines which connect to the drive USB connector.

5. The power adapter according to claim 4, wherein, in the power supply current combining circuit, the power supply line extending from the main USB connector and the power supply line extending from the assist USB connector connect to each other via reverse-current-preventing diodes so as to be combined into a common line which connects to the drive USB connector.

6. The power adapter according to claim 4, wherein the power supply current combining circuit comprises:
a first MOS-FET provided in the power supply line extending from the main USB connector;
a second MOS-FET provided in the power supply line extending from the assist USB connector;
an output power supply line that connects output sides of the first and second MOS-FETs in common and that connects to a load;
a first operational amplifier that receives an input-side voltage and an output-side voltage to the first MOS-FET, that performs control to turn on the first MOS-FET so as to supply power to the load when the input-side voltage is the same as or higher than the output-side voltage, and that performs control to turn off the first MOS-FET so as to prevent a reverse current to the input side when the input-side voltage is lower than the output-side voltage;
a second operational amplifier that receives an input-side voltage and an output-side voltage to the second MOS-FET, that performs control to turn on the second MOS-FET so as to supply power to the load when the input-side voltage is the same as or higher than the output-side voltage, and that performs control to turn off the second MOS-FET so as to prevent a reverse current to the input side when the input-side voltage is lower than the output-side voltage; and
a booster circuit that boosts a power supply voltage supplied through the power supply line extending from the main USB connector or the assist USB connector and that supplies the boosted power supply voltage to the first and second operational amplifiers.

7. The power adapter according to claim 6,
wherein the first and second MOS-FETs are N-channel MOS-FETs and have sources connected to a power input side and drains connected to a power output side,
wherein the output power supply line connects the drains of the first and second N-channel MOS-FETs in common and connects to the load,
wherein the first operational amplifier has a noninverting input terminal connected to the source of the first N-channel MOS-FET and an inverting input terminal connected to the drain of the first N-channel MOS-FET, performs control to turn on the first N-channel MOS-FET so as to supply power to the load when an input-side source voltage is the same as or higher than an output-side drain voltage, and performs control to turn off the first N-channel MOS-FET so as to prevent a reverse current to the input side when the input-side source voltage is lower than the output-side drain voltage, and
wherein the second operational amplifier has a noninverting input terminal connected to the source of the second N-channel MOS-FET and an inverting input terminal connected to the drain of the second N-channel MOS-FET, performs control to turn on the second N-channel MOS-FET so as to supply power to the load when an input-side source voltage is the same as or higher than an output-side drain voltage, and performs control to turn off the second N-channel MOS-FET so as to prevent a reverse current to the input side when the input-side source voltage is lower than the output-side drain voltage.

8. The power adapter according to claim 6,
wherein the first and second MOS-FETs are P-channel MOS-FETs and have drains connected to a power input side and sources connected to a power output side,
wherein the output power supply line connects the sources of the first and second P-channel MOS-FETs in common and connects to the load,
wherein the first operational amplifier has a noninverting input terminal connected to the source of the first P-channel MOS-FET and an inverting input terminal connected to the drain of the first P-channel MOS-FET, performs control to turn on the first P-channel MOS-FET so as to supply power to the load when an input-side drain voltage is the same as or higher than an output-side source voltage, and performs control to turn off the first P-channel MOS-FET so as to prevent a reverse current to the input side when the input-side drain voltage is lower than the output-side source voltage, and
wherein the second operational amplifier has a noninverting input terminal connected to the source of the second P-channel MOS-FET and an inverting input terminal connected to the drain of the second P-channel MOS-FET, performs control to turn on the second P-channel MOS-FET so as to supply power to the load when an input-side drain voltage is the same as or higher than an output-side source voltage, and performs control to turn off the second P-channel MOS-FET so as to prevent a reverse current to the input side when the input-side drain voltage is lower than the output-side source voltage.

9. A power adapter to connect a host apparatus to an external storage apparatus through USB cables via connectors, the power adapter comprising:
a main USB connector that includes a power supply terminal, a ground terminal, and a pair of signal terminals and that is externally connected to a main USB cable extending from the host apparatus;
an assist USB connector that includes a power supply terminal, a ground terminal, and a pair of signal terminals and that is externally connected to an assist USB cable extending from the host apparatus;
a DC jack that includes a power supply terminal and a ground terminal and that is externally connected to an adapter cable extending from an AC adapter to convert AC power to DC power;
a drive USB connector that includes a power supply terminal, a ground terminal, and a pair of signal terminals and that is externally connected to a USB cable extending from the storage apparatus; and
a power supply current combining circuit that combines a current from the power supply terminal of the main USB connector, a current from the power supply terminal of the assist USB connector, and a current from the power supply terminal of the DC jack so as to output a combined current to the power supply terminal of the drive USB connector and that mutually inputs/outputs signals between the signal terminals of the main USB connector and the signal terminals of the drive USB connector.

10. The power adapter according to claim 9, wherein the main USB connector and the assist USB connector are B-type USB female connectors or mini-B-type USB female connectors, and wherein the drive USB connector is an A-type USB connector.

11. The power adapter according to claim 9, wherein the main USB connector and the assist USB connector are B-type USB female connectors or mini-B-type USB female connectors, and wherein the drive USB connector is a B-type USB female connector or a mini-B-type USB female connector connected to a USB cable extending from the inside of the adapter to the outside.

12. The power adapter according to claim 9, wherein, in the power supply current combining circuit, a power supply line and a ground line extending from the main USB connector, a power supply line and a ground line extending from the assist USB connector, and a power supply line and a ground line extending from the DC jack connect to each other, respectively, so as to be combined into common lines which connect to the drive USB connector.

13. The power adapter according to claim 12, wherein, in the power supply current combining circuit, the power supply line extending from the main USB connector, the power supply line extending from the assist USB connector, and the power supply line extending from the DC jack connect to each other via reverse-current-preventing diodes so as to be combined into a common line which connects to the drive USB connector.

14. The power adapter according to claim 12, wherein the power supply current combining circuit comprises:
a first MOS-FET provided in the power supply line extending from the main USB connector;
a second MOS-FET provided in the power supply line extending from the assist USB connector;
a third MOS-FET provided in the power supply line extending from the DC jack;
an output power supply line that connects output sides of the first, second, and third MOS-FETs in common and that connects to a load;
a first operational amplifier that receives an input-side voltage and an output-side voltage to the first MOS-FET, that performs control to turn on the first MOS-FET so as to supply power to the load when the input-side voltage is the same as or higher than the output-side voltage, and that performs control to turn off the first MOS-FET so as to prevent a reverse current to the input side when the input-side voltage is lower than the output-side voltage;
a second operational amplifier that receives an input-side voltage and an output-side voltage to the second MOS-FET, that performs control to turn on the second MOS-FET so as to supply power to the load when the input-side voltage is the same as or higher than the output-side voltage, and that performs control to turn off the second MOS-FET so as to prevent a reverse current to the input side when the input-side voltage is lower than the output-side voltage;
a third operational amplifier that receives an input-side voltage and an output-side voltage to the third MOS-FET, that performs control to turn on the third MOS-FET so as to supply power to the load when the input-side voltage is the same as or higher than the output-side voltage, and that performs control to turn off the third MOS-FET so as to prevent a reverse current to the input side when the input-side voltage is lower than the output-side voltage; and
a booster circuit that boosts a power supply voltage supplied through the power supply line extending from the main USB connector or the assist USB connector and that supplies the boosted power supply voltage to the first, second, and third operational amplifiers.

15. The power adapter according to claim 14,
wherein the first, second, and third MOS-FETs are N-channel MOS-FETs and have sources connected to a power input side and drains connected to a power output side,
wherein the output power supply line connects the drains of the first, second, and third N-channel MOS-FETs in common and connects to the load,
wherein the first operational amplifier has a noninverting input terminal connected to the source of the first N-channel MOS-FET and an inverting input terminal connected to the drain of the first N-channel MOS-FET, performs control to turn on the first N-channel MOS-FET so as to supply power to the load when an input-side source voltage is the same as or higher than an output-side drain voltage, and performs control to turn off the first N-channel MOS-FET so as to prevent a reverse current to the input side when the input-side source voltage is lower than the output-side drain voltage,
wherein the second operational amplifier has a noninverting input terminal connected to the source of the second N-channel MOS-FET and an inverting input terminal connected to the drain of the second N-channel MOS-FET, performs control to turn on the second N-channel MOS-FET so as to supply power to the load when an input-side source voltage is the same as or higher than an output-side drain voltage, and performs control to turn off the second N-channel MOS-FET so as to prevent a reverse current to the input side when the input-side source voltage is lower than the output-side drain voltage, and
wherein the third operational amplifier has a noninverting input terminal connected to the source of the third N-channel MOS-FET and an inverting input terminal connected to the drain of the third N-channel MOS-FET, performs control to turn on the third N-channel MOS-FET so as to supply power to the load when an input-side source voltage is the same as or higher than an output-side drain voltage, and performs control to turn off the third N-channel MOS-FET so as to prevent a reverse current to the input side when the input-side source voltage is lower than the output-side drain voltage.

16. The power adapter according to claim 14,
wherein the first, second, and third MOS-FETs are P-channel MOS-FETs and have drains connected to a power input side and sources connected to a power output side,
wherein the output power supply line connects the sources of the first, second, and third P-channel MOS-FETs in common and connects to the load,
wherein the first operational amplifier has a noninverting input terminal connected to the source of the first P-channel MOS-FET and an inverting input terminal connected to the drain of the first P-channel MOS-FET, performs control to turn on the first P-channel MOS-FET so as to supply power to the load when an input-side drain voltage is the same as or higher than an output-side source voltage, and performs control to turn off the first P-channel MOS-FET so as to prevent a reverse current to the input side when the input-side drain voltage is lower than the output-side source voltage,
wherein the second operational amplifier has a noninverting input terminal connected to the source of the second P-channel MOS-FET and an inverting input terminal connected to the drain of the second P-channel MOS-FET, performs control to turn on the second P-channel MOS-FET so as to supply power to the load when an input-side drain voltage is the same as or higher than an output-side source voltage, and performs control to turn off the second P-channel MOS-FET so as to prevent a reverse current to the input side when the input-side drain voltage is lower than the output-side source voltage, and
wherein the third operational amplifier has a noninverting input terminal connected to the source of the third P-channel MOS-FET and an inverting input terminal connected to the drain of the third P-channel MOS-FET, performs control to turn on the third P-channel MOS-FET so as to supply power to the load when an input-side drain voltage is the same as or higher than an output-side source voltage, and performs control to turn off the third P-channel MOS-FET so as to prevent a reverse current to the input side when the input-side drain voltage is lower than the output-side source voltage.

17. The power adapter according to claim 14, wherein the booster circuit is a voltage doubler circuit having a switched-capacitor configuration or a booting DC-DC converter.

18. A storage apparatus externally connected to a host apparatus via a USB interface, the storage apparatus comprising:
a first USB connector from which a power supply line, a ground line, and a pair of signal lines extend;
a second USB connector from which only a power supply line and a ground line extend;
a first MOS-FET provided in the power supply line extending from the first USB connector;
a second MOS-FET provided in the power supply line extending from the second USB connector;
an output power supply line that connects output sides of the first and second MOS-FETs in common and that connects to a load;
a first operational amplifier that receives an input-side voltage and an output-side voltage to the first MOS-FET, that performs control to turn on the first MOS-FET so as to supply power to the load when the input-side voltage is the same as or higher than the output-side voltage, and that performs control to turn off the first MOS-FET so as to prevent a reverse current to the input side when the input-side voltage is lower than the output-side voltage;
a second operational amplifier that receives an input-side voltage and an output-side voltage to the second MOS-FET, that performs control to turn on the second MOS-FET so as to supply power to the load when the input-side voltage is the same as or higher than the output-side voltage, and that performs control to turn off the second MOS-FET so as to prevent a reverse current to the input side when the input-side voltage is lower than the output-side voltage; and
a booster circuit that boosts a power supply voltage supplied through the power supply line extending from the first USB connector or the second USB connector and that supplies the boosted power supply voltage to the first and second operational amplifiers.

19. The storage apparatus according to claim 18,
wherein the first and second MOS-FETs are N-channel MOS-FETs and have sources connected to a power input side and drains connected to a power output side,
wherein the output power supply line connects the drains of the first and second N-channel MOS-FETs in common and connects to the load,
wherein the first operational amplifier has a noninverting input terminal connected to the source of the first N-channel MOS-FET and an inverting input terminal connected to the drain of the first N-channel MOS-FET, performs control to turn on the first N-channel MOS-FET so as to supply power to the load when an input-side source voltage is the same as or higher than an output-side drain voltage, and performs control to turn off the first N-channel MOS-FET so as to prevent a reverse current to the input side when the input-side source voltage is lower than the output-side drain voltage, and
wherein the second operational amplifier has a noninverting input terminal connected to the source of the second N-channel MOS-FET and an inverting input terminal connected to the drain of the second N-channel MOS-FET, performs control to turn on the second N-channel MOS-FET so as to supply power to the load when an input-side source voltage is the same as or higher than an output-side drain voltage, and performs control to turn off the second N-channel MOS-FET so as to prevent a reverse current to the input side when the input-side source voltage is lower than the output-side drain voltage.

20. The storage apparatus according to claim 18,
wherein the first and second MOS-FETs are P-channel MOS-FETs and have drains connected to a power input side and sources connected to a power output side,
wherein the output power supply line connects the sources of the first and second P-channel MOS-FETs in common and connects to the load,
wherein the first operational amplifier has a noninverting input terminal connected to the source of the first P-channel MOS-FET and an inverting input terminal connected to the drain of the first P-channel MOS-FET, performs control to turn on the first P-channel MOS-FET so as to supply power to the load when an input-side drain voltage is the same as or higher than an output-side source voltage, and performs control to turn off the first P-channel MOS-FET so as to prevent a reverse current to the input side when the input-side drain voltage is lower than the output-side source voltage, and
wherein the second operational amplifier has a noninverting input terminal connected to the source of the second P-channel MOS-FET and an inverting input terminal connected to the drain of the second P-channel MOS-FET, performs control to turn on the second P-channel MOS-FET so as to supply power to the load when an input-side drain voltage is the same as or higher than an output-side source voltage, and performs control to turn off the second P-channel MOS-FET so as to prevent a reverse current to the input side when the input-side drain voltage is lower than the output-side source voltage.
